(19) United States
(12) Patent Application Publication
(10) Pub. No.: US 2025/0271820 A1
(43) Pub. Date: Aug. 28, 2025

(54) INFORMATION PROCESSING METHOD, INFORMATION OPTIMIZATION METHOD, INFORMATION PROCESSING DEVICE, AND PROGRAM

(71) Applicant: PANASONIC INTELLECTUAL PROPERTY MANAGEMENT CO., LTD., Osaka (JP)

(72) Inventors: Taichi SATO, Kyoto (JP); Taichi SHIMIZU, Osaka (JP); Shun TAKAYANAGI, Osaka (JP); Yuto KITAGAWA, Osaka (JP); Naganori SHIRAKATA, Osaka (JP); Shunsaku TOSHIHIRO, Osaka (JP); Koushin KAI, Osaka (JP)

(21) Appl. No.: 18/858,141

(22) PCT Filed: Mar. 20, 2023
(86) PCT No.: PCT/JP2023/010882

§ 371 Date: Oct. 18, 2024

(30) Foreign Application Priority Data
Apr. 21, 2022 (JP) 2022-070396
Apr. 21, 2022 (JP) 2022-070397

(51) Int. Cl. G05B 13/02

(52) U.S. Cl. CPC G05B 13/024

(57) ABSTRACT

An information processing method for optimizing a plurality of control parameters in a device that performs a plurality of operations based on the plurality of control parameters, the method including by an information processing device: in control parameter optimization processing, selecting a representative operation including at least one operation among all of the plurality of operations capable of being performed by the device, causing the device to perform the selected representative operation, acquiring measurement data regarding an operation of the device, the measurement data being measured by performing the representative operation, calculating an evaluation value of a predetermined evaluation index based on the acquired measurement data, and updating the plurality of control parameters based on the calculated evaluation value; and executing the control parameter optimization processing a plurality of times while changing an evaluation criterion of the control parameter optimization processing.

### TECHNICAL FIELD

The present disclosure relates to an information processing method, an information optimization method, an information processing device, and a program.

### BACKGROUND ART

A conventionally known method is a control parameter generation method for generating control parameters (see, for example, Patent Literature 1).

It has been conventionally desired to efficiently generate appropriate control parameters.

### CITATION LIST

### Patent Literature

Patent Literature 1: WO 2018/151215 A

### SUMMARY OF INVENTION

It is an object of the present disclosure to provide an information processing method, an information optimization method, an information processing device, and a program capable of efficiently generating appropriate control parameters.

### Means for Solving the Problem

An information processing method according to one aspect of the present disclosure is an information processing method for optimizing a plurality of control parameters in a device that performs a plurality of operations based on the plurality of control parameters, the method including: by an information processing device, in control parameter optimization processing, selecting a representative operation including at least one operation among all of the plurality of operations capable of being performed by the device, causing the device to perform the selected representative operation, acquiring measurement data regarding an operation of the device, the measurement data being measured by performing the representative operation, calculating an evaluation value of a predetermined evaluation index based on the acquired measurement data, and updating the plurality of control parameters based on the calculated evaluation value; and executing the control parameter optimization processing a plurality of times while changing an evaluation criterion of the control parameter optimization processing.

An information optimization method according to one aspect of the present disclosure includes: by an information processing device, executing first optimization processing on information using a first evaluation criterion; setting a search range of the information based on a plurality of evaluation values calculated in the first optimization processing; and executing second optimization processing on the information regarding the set search range using a second evaluation criterion.

An information processing device according to one aspect of the present disclosure is an information processing device that optimizes a plurality of control parameters in a device that performs a plurality of operations based on the plurality of control parameters, the device including: a selection unit; a control unit; an acquisition unit; a calculation unit; and an updating unit, wherein in the control parameter optimization processing, the selection unit selects a representative operation including at least one operation among all of the plurality of operations capable of being performed by the device, the control unit causes the device to perform the representative operation selected by the selection unit, the acquisition unit acquires measurement data regarding an operation of the device measured in performing the representative operation, the calculation unit calculates an evaluation value of a predetermined evaluation index based on the measurement data acquired by the acquisition unit, the updating unit updates the plurality of control parameters based on the evaluation value calculated by the calculation unit, and the control parameter optimization processing is executed a plurality of times while an evaluation criterion of the control parameter optimization processing is being changed.

A program according to one aspect of the present disclosure is a program for causing an information processing device to function as a selection means, a control means, an acquisition means, a calculation means, and an updating means, the information processing device optimizing a plurality of control parameters in a device that performs a plurality of operations based on the plurality of control parameters, wherein in control parameter optimization processing, the selection means selects a representative operation including at least one operation among all of the plurality of operations capable of being performed by the device, the control means causes the device to perform the representative operation selected by the selection means, the acquisition means acquires measurement data regarding an operation of the device measured in performing the representative operation, the calculation means calculates an evaluation value of a predetermined evaluation index based on the measurement data acquired by the acquisition means, the updating means updates the plurality of control parameters based on the evaluation value calculated by the calculation means, and the control parameter optimization processing is executed a plurality of times while an evaluation criterion of the control parameter optimization processing is being changed.

### Effect of the Invention

According to the present disclosure, appropriate control parameters can be efficiently generated.

### BRIEF DESCRIPTION OF DRAWINGS

FIG. 1 is a schematic diagram illustrating an outline of a control parameter generation system according to a first embodiment.

FIG. 2 is a block diagram illustrating a configuration of the control parameter generation system according to the first embodiment.

FIG. 3 is a perspective view illustrating one example of a production device according to the first embodiment.

FIG. 4 is a data configuration diagram illustrating one example of control parameters stored in a memory according to the first embodiment.

FIG. 5 is a schematic diagram illustrating one example of transition of a positional deviation of an object to be driven with respect to a target position.

FIG. 6 is a data configuration table illustrating one example of measurement data output from the sensor according to the first embodiment.

FIG. 7 is a flowchart of first control parameter generation processing.

FIG. 8 is a sequence diagram of the first control parameter generation processing.

FIG. 9 is a schematic diagram illustrating one example of an image displayed by a display unit according to the first embodiment.

FIG. 10 is a flowchart of condition acquisition processing.

FIG. 11 is a schematic diagram illustrating one example of an image displayed by the display unit according to the first embodiment.

FIG. 12 is a flowchart of representative operation designation processing.

FIG. 13 is a schematic diagram illustrating one example of an image displayed by the display unit according to the first embodiment.

FIG. 14 is a schematic diagram illustrating an experimental result of an experiment conducted by the inventors.

FIG. 15 is a block diagram illustrating a configuration of a control parameter generation system according to a second embodiment.

FIG. 16A is a schematic diagram illustrating one example of transition of a positional deviation of an object to be driven with respect to a target position.

FIG. 16B is a schematic diagram illustrating one example of transition of the positional deviation of the object to be driven with respect to a target position.

FIG. 17 is a flowchart of second control parameter generation processing.

FIG. 18 is a flowchart of third control parameter generation processing.

FIG. 19 is a schematic diagram illustrating one example of a state where a determination unit according to a third embodiment selects X representative operations from Y operations.

FIG. 20 is a flowchart of parameter updating processing by all operations.

FIG. 21 is a flowchart of first control parameter generation processing.

FIG. 22 is a flowchart illustrating a flow of processing executed by an information processing unit.

FIG. 23 is a diagram schematically illustrating a method for setting a search range by a generation unit.

FIG. 24 is a diagram illustrating operation condition information in which an operation condition of each operation performed by the production device is partially simplified to be described.

FIG. 25 is a flowchart illustrating a flow of processing executed by the information processing unit in association with notification of status information to a user.

FIG. 26 is a diagram illustrating one example of a status notification image.

### DESCRIPTION OF EMBODIMENTS

### (How One Aspect of Present Disclosure Has Come About)

As a method for generating appropriate control parameters of a drive source in a production device (for example, a mounting device) including the drive source (for example, a servomotor) that drives an object to be driven, in recent years, a method for generating appropriate control parameters by searching for appropriate control parameters using a machine learning model or the like has been proposed (see, for example, Patent Literature 1).

In general, the number of control parameters of the drive source used in the production device may be 50 or more. Further, a number of adjustment gradations may be 100 or more.

For example, in a case where the production device performs 80 operations, the number of control parameters of the drive source is 50, and the number of adjustment gradations of the control parameters is 100, the number of combinations thereof is 100⁵⁰×80.

The inventors have found a problem that in a case where control parameters are generated for such an enormous number of combinations, at a time of using a method for searching for appropriate control parameters using a machine learning model or the like, enormous time is required to search for appropriate control parameter or no matter how much time it takes, no appropriate control parameter cannot be acquired due to an excessively wide search range.

Therefore, the inventors have intensively repeated experiments and studies in order to achieve a parameter generation method capable of efficiently generating appropriate control parameters even in a case where control parameters are generated for an enormous number of combinations.

Through the above experiments and studies, the inventors have obtained findings such that, in a case where, for example, 80 operations are performed by the production device, appropriate control parameters can be generated more efficiently and reliably for combinations of all the 80 operations by repeating steps described below and finally searching for appropriate parameters for all the 80 operations without searching for appropriate control parameters for all huge combinations from the beginning. The steps include a first step of searching for appropriate control parameters for some of the 80 operations, for example, only a combination of one operation, that is, only some combinations among the huge combinations, a next step of increasing the number of operations performed by the production device and searching for appropriate control parameters for a combination of two operations using a search result in the first step, and a still next step of further increasing the number of operations performed by the production device and searching for appropriate control parameters, for example, for a combination of four operations using a search result in the previous step.

The inventors further conducted experiments and studies based on the above findings, and conceived a control parameter generation method and the like according to the present disclosure described below.

An information processing method according to a first aspect of the present disclosure is an information processing method for optimizing a plurality of control parameters in a device that performs a plurality of operations based on the plurality of control parameters, the method including: by an information processing device, in control parameter optimization processing, selecting representative operation including at least one operation among all of the plurality of operations capable of being performed by the device; causing the device to perform the selected representative operation, acquiring measurement data regarding an operation of the device, the measurement data being measured by performing the representative operation; calculating an evaluation value of a predetermined evaluation index based on the acquired measurement data, and updating the plurality of control parameters based on the calculated evaluation value, and executing the control parameter optimization processing a plurality of times while changing an evaluation criterion of the control parameter optimization processing.

According to the first aspect, the control parameter optimization processing is executed a plurality of times while the evaluation criterion of the control parameter optimization processing is being changed. As described above, the appropriate control parameters can be efficiently generated by repeatedly executing the control parameter optimization processing while changing the evaluation criterion.

In accordance with a second aspect of the present disclosure, in the information processing method according to the first aspect, the changing the evaluation criterion may include changing the representative operation.

According to the second aspect, the evaluation criterion can be changed by changing the representative operation.

In accordance with a third aspect of the present disclosure, in the information processing method according to the second aspect, the changing the representative operation may include changing a number of operations in the representative operation.

According to the third aspect, the evaluation criterion can be changed by changing the number of operations in the representative operation.

In accordance with a fourth aspect of the present disclosure, in the information processing method according to the third aspect, the changing the number of operations may include increasing the number of operations.

According to the fourth aspect, appropriate control parameters can be efficiently generated by repeating the control parameter optimization processing while gradually increasing the number of operations included in the representative operation.

In accordance with a fifth aspect of the present disclosure, in the information processing method according to the second aspect, the changing the representative operation may include changing contents of an operation included in the representative operation.

According to the fifth aspect, the evaluation criterion can be changed by changing the contents of an operation included in the representative operation.

In accordance with a sixth aspect of the present disclosure, in the information processing method according to the fifth aspect, the changing the contents of the operation may include making the contents of the operation complicated.

According to the sixth aspect, appropriate control parameters can be efficiently generated by repeating the control parameter optimization processing while gradually making the contents of the operation included in the representative operation complicated.

In accordance with a seventh aspect of the present disclosure, in the information processing method according to any one of the second to sixth aspects, in the changing the representative operation, all of the plurality of operations may be classified into a plurality of groups based on similarity, an operation to be improved may be designated among the plurality of operations included in each of the plurality of groups based on the evaluation value or a past average value of the evaluation value, and a plurality of the operations to be improved designated for the plurality of groups may be selected as the representative operation in the control parameter optimization processing at a next time.

According to the seventh aspect, appropriate control parameters can be efficiently generated by selecting the plurality of the operation to be improved designated for the plurality of groups as the representative operation in the control parameter optimization processing at a next time.

In accordance with an eighth aspect of the present disclosure, in the information processing method according to any one of the first to seventh aspects, the changing the evaluation criterion may include changing the evaluation index.

According to the eighth aspect, the evaluation criterion can be changed by changing the evaluation index.

In accordance with a ninth aspect of the present disclosure, in the information processing method according to the eighth aspect, each of the plurality of operations is an operation for causing the device to transfer an object to a target position, and the evaluation index may include a settling time until a positional deviation between a position of the object and the target position converges within an allowable range.

According to the ninth aspect, control parameters can be appropriately evaluated by using the settling time as the evaluation index.

In accordance with a tenth aspect of the present disclosure, in the information processing method according to the eighth aspect, each of the plurality of operations is an operation for causing the device to transfer an object to a target position, and the evaluation index may include an integrated value of a deviation time at which a positional deviation between a position of the object and the target position deviates from an allowable range or of a positional deviation amount.

According to the tenth aspect, control parameters can be appropriately evaluated by using the integrated value of the deviation time or of the positional deviation amount as the evaluation index.

In accordance with an eleventh aspect of the present disclosure, the information processing method according to any one of the first to tenth aspects may further include setting a search range of the control parameters that are update candidates in the control parameter optimization processing at a next time, based on a plurality of the evaluation values calculated in the control parameter optimization processing at a current time.

According to the eleventh aspect, by taking over the setting information about the search range of the control parameters from the control parameter optimization processing at the current time to the control parameter optimization processing at the next time, appropriate control parameters can be efficiently search for in the control parameter optimization processing at the next time.

In accordance with a twelfth aspect of the present disclosure, the information processing method according to any one of the first to eleventh aspects may further include: causing the device to perform a predetermined evaluation operation for comprehensively evaluating an operation of the device in comprehensive evaluation processing; acquiring measurement data regarding the operation of the device measured in the performing of the evaluation operation; calculating an evaluation value of the evaluation index based on the acquired measurement data; and making the comprehensive evaluation based on the calculated evaluation value.

According to the twelfth aspect, the progress of the control parameter optimization in all the operations of the device can be evaluated by the comprehensive evaluation processing.

In accordance with a thirteenth aspect of the present disclosure, in the information processing method according to the twelfth aspect, the evaluation operation may be all the operations.

According to the thirteenth aspect, accurate comprehensive evaluation can be made by causing the device to perform all the operations as the evaluation operation.

In accordance with a fourteenth aspect of the present disclosure, in the information processing method according to the twelfth aspect, the evaluation operation may be a differential operation between all the operations and a most recent representative operation with respect to the evaluation operation.

According to the fourteenth aspect, by causing, as the evaluation operation, the device to perform the differential operation between all the operations and the most recent representative operation with respect to the evaluation operation, the efficiency of the evaluation operation can be improved while the accuracy of the comprehensive evaluation is being maintained.

In accordance with a fifteenth aspect of the present disclosure, in the information processing method according to the twelfth aspect, the evaluation operation may be a prescribed operation defined in advance from all the operations.

According to the fifteenth aspect, as the evaluation operation, the efficiency of the evaluation operation can be improved by causing the device to perform the prescribed operation defined in advance from all the operations.

In accordance with a sixteenth aspect of the present disclosure, the information processing method according to any one of the twelfth to fifteenth aspects may further include: determining whether the evaluation result of the comprehensive evaluation satisfies a predetermined end condition, and ending the control parameter optimization processing in a case where the evaluation result satisfies the end condition.

According to the sixteenth aspect, in a case where the evaluation result of the comprehensive evaluation satisfies the predetermined end condition, the control parameter optimization processing ends even before the control parameter optimization processing arrives at the final stage, and thus the time required for the processing can be shortened.

In accordance with a seventeenth aspect of the present disclosure, in the information processing method according to any one of the first to sixteenth aspects, each of the plurality of operations is an operation for causing the device to transfer an object to a target position, and the method may further include outputting, to a user for a notification, status information regarding at least one of: an elapsed time from start of the control parameter optimization processing; a remaining time until a maximum time for continuing the control parameter optimization processing; an operation condition including at least one of identification information, a transfer amount, a transfer speed, an acceleration time, and a deceleration time regarding an operation being currently performed among the at least one operation included in the representative operation; a number of operations included in the representative operation, a number of update times of the control parameters; and a remaining number of times up to a maximum number of times of updating the control parameters.

According to the seventeenth aspect, the user can easily check the progress status, the operation conditions, or the like of the control parameter optimization processing through the notification by outputting the status information for the notification to the user, and thus, convenience for the user can be improved.

In accordance with an eighteenth aspect of the present disclosure, the information processing method according to the seventeenth aspect may further include updating the status information every time the evaluation criterion is changed.

According to the eighteenth aspect, the latest status information can be notified to the user by updating the status information every time the evaluation criterion is changed.

In accordance with a nineteenth aspect of the present disclosure, the information processing method according to the seventeenth aspect may further include setting the maximum time, the operation condition, and the maximum number of times based on condition setting information input by a user.

According to the nineteenth aspect, the user can randomly set the maximum time, the operation condition, and the maximum number of times.

In accordance with a twentieth aspect of the present disclosure, in the information processing method according to the seventeenth aspect, the operation condition is preset for each device, and the method may further include setting the operation condition in accordance with the selected device based on device selection information input by a user.

According to the twentieth aspect, it is possible to automatically set an appropriate operation condition in accordance with the device selected by the user.

In accordance with a twenty-first aspect of the present disclosure, the information processing method according to any one of the first to twentieth aspects may further include recording operation history information including a performing time and an operation condition for each operation performed by the device in the control parameter optimization processing.

According to the twenty-first aspect, the operation history information can be provided to a user by recording the operation history information including a performing time and an operation condition for each operation performed by the device.

An information optimization method according to a twenty-second aspect of the present disclosure includes: by an information processing device, executing first optimization processing on information using a first evaluation criterion; setting a search range of the information based on a plurality of evaluation values calculated in the first optimization processing; and executing second optimization processing on the information regarding the set search range using a second evaluation criterion.

According to the twenty-second aspect, the second optimization processing can be efficiently executed by taking over the setting information about the search range from the first optimization processing to the second optimization processing.

An information processing device according to a twenty-third aspect of the present disclosure is an information processing device that optimizes a plurality of control parameters in a device that performs a plurality of operations based on the plurality of control parameters, the device including: a selection unit; a control unit; an acquisition unit; a calculation unit; and an updating unit, wherein in control parameter optimization processing, the selection unit selects a representative operation including at least one operation among all of the plurality of operations capable of being performed by the device, the control unit causes the device to perform the representative operation selected by the selection unit, the acquisition unit acquires measurement data regarding an operation of the device measured in performing the representative operation, the calculation unit calculates an evaluation value of a predetermined evaluation index based on the measurement data acquired by the acquisition unit, the updating unit updates the plurality of control parameters based on the evaluation value calculated by the calculation unit, and the control parameter optimization processing is executed a plurality of times while an evaluation criterion of the control parameter optimization processing is being changed.

According to the twenty-third aspect, the control parameter optimization processing is executed a plurality of times while the evaluation criterion of the control parameter optimization processing is being changed. As described above, the appropriate control parameters can be efficiently generated by repeatedly executing the control parameter optimization processing while changing the evaluation criterion.

A program according to a twenty-fourth aspect of the present disclosure is a program for causing an information processing device to function as a selection means, a control means, an acquisition means, a calculation means, and an updating means, the information processing device optimizing a plurality of control parameters in a device that performs a plurality of operations based on the plurality of control parameters, wherein in control parameter optimization processing, the selection means selects a representative operation including at least one operation among all of the plurality of operations capable of being performed by the device, the control means causes the device to perform the representative operation selected by the selection means, the acquisition means acquires measurement data regarding an operation of the device measured in performing the representative operation, the calculation means calculates an evaluation value of a predetermined evaluation index based on the measurement data acquired by the acquisition means, the updating means updates the plurality of control parameters based on the evaluation value calculated by the calculation means, and the control parameter optimization processing is executed a plurality of times while an evaluation criterion of the control parameter optimization processing is being changed.

According to the twenty-fourth aspect, the control parameter optimization processing is executed a plurality of times while the evaluation criterion of the control parameter optimization processing is being changed. As described above, the appropriate control parameters can be efficiently generated by repeatedly executing the control parameter optimization processing while changing the evaluation criterion.

Hereinafter, specific examples of the control parameter generation system according to one aspect of the present disclosure will be described with reference to the drawings. Each of embodiments to be described here illustrates one specific example of the present disclosure. Therefore, the following embodiments describe numerical values, shapes, components, placement of the components, connection forms, steps, the order of steps, and the like that are merely examples and are not intended to limit the present disclosure. Each of the drawings is a schematic diagram, and is not necessarily strictly illustrated. In the drawings, substantially the same components are denoted by the same reference numerals, and redundant description will be omitted or simplified.

### FIRST EMBODIMENT

Hereinafter, a control parameter generation system according to a first embodiment will be described. This control parameter generation system is a system that generates control parameters used for a production device including a drive source that drives an object to be driven.

### <Configuration>

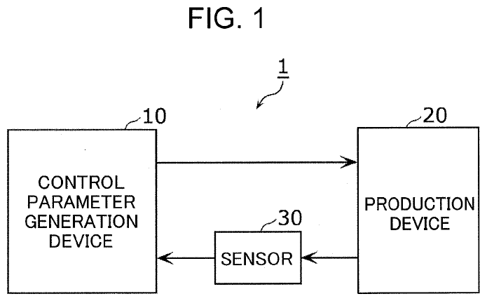

FIG. 1 is a schematic diagram illustrating an outline of a control parameter generation system 1 according to the first embodiment.

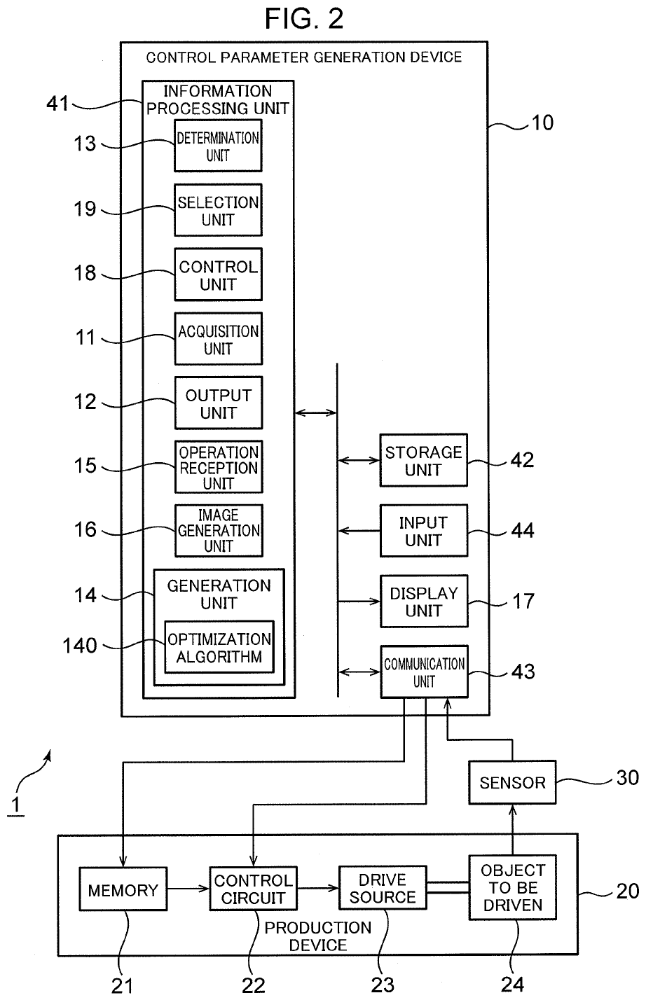

FIG. 2 is a block diagram illustrating a configuration of the control parameter generation system 1.

As illustrated in FIG. 1, the control parameter generation system 1 includes a control parameter generation device 10, a production device 20, and a sensor 30.

The production device 20 is a device used to produce equipment, and performs mounting, processing, machining, conveyance, and the like of the equipment. The production device 20 is installed, for example, in a production line of a factory. Specifically, the production device 20 is a mounting device, a processing device, a machining device, a conveyance device, or the like. The production device 20 performs N (N is an integer of 3 or more) operations. The integer N is, for example, 80.

As illustrated in FIG. 2, the production device 20 includes a memory 21, a control circuit 22, a drive source 23, and an object to be driven 24.

The control circuit 22 controls an operation of the drive source 23, and drives the object to be driven 24.

Specifically, the drive source 23 is, for example, a servomotor, a fluid directional flow control valve used for controlling a pneumatic artificial muscle arm, or a fluid directional flow control valve used for controlling a hydraulic arm. The servomotor may be, for example, a rotary motor or a linear motor.

The object to be driven 24 is an object to be driven by the drive source 23. For example, in a case where the drive source 23 is a servomotor, the object to be driven 24 is a head that carries a part to be machined, a nozzle provided at the head to suck the part to be machined, or the like. In addition, the object to be driven 24 is a pneumatic artificial muscle arm, a hydraulic arm, or the like when the drive source 23 is a directional flow control valve.

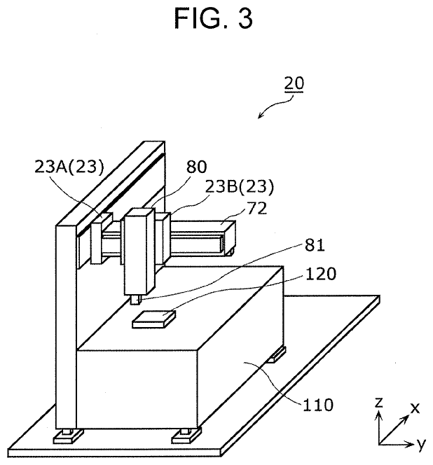

FIG. 3 is a perspective view of the production device 20 having a configuration where the drive source 23 is a servomotor and the object to be driven 24 is a nozzle provided at a head, as an example.

As illustrated in FIG. 3, the production device 20 may be, for example, a mounting device in which components are mounted on a substrate 120 placed on a machine table 110.

As an example, the production device 20 includes a nozzle 81 that sucks a component, a head 80 having the nozzle 81, a servomotor 23A that functions as the drive source 23 for moving the head 80 in an X-axis direction in plan view of the machine table 110, and a servomotor 23B that functions as the drive source 23 for moving the head in a Y-axis direction. Here, the head 80 is connected to the servomotor 23A via an arm 72 and the servomotor 23B.

Returning again to FIGS. 1 and 2, the description about the control parameter generation system 1 will be continued.

The control circuit 22 outputs, to the drive source 23, a command for setting the position of the object to be driven 24 to a predetermined target position to control the drive source 23. The command output from the control circuit 22 to the drive source 23 may be, for example, a position command for commanding the position of the drive source 23 or the object to be driven 24, or may be, for example, a torque command for commanding a torque of the drive source 23.

The control circuit 22 controls the drive source 23 based on control parameters stored in the memory 21. In other words, the control circuit 22 uses the control parameters stored in the memory 21 when controlling the drive source 23. The number of control parameters is, for example, 50.

The memory 21 stores control parameters used when the control circuit 22 controls the drive source 23. The control parameters stored in the memory 21 are control parameters output from the control parameter generation device 10.

When the control parameters are output from the control parameter generation device 10, the memory 21 acquires the output control parameters, and updates control parameter to be stored using the acquired control parameters, that is, overwrites and stores the control parameters.

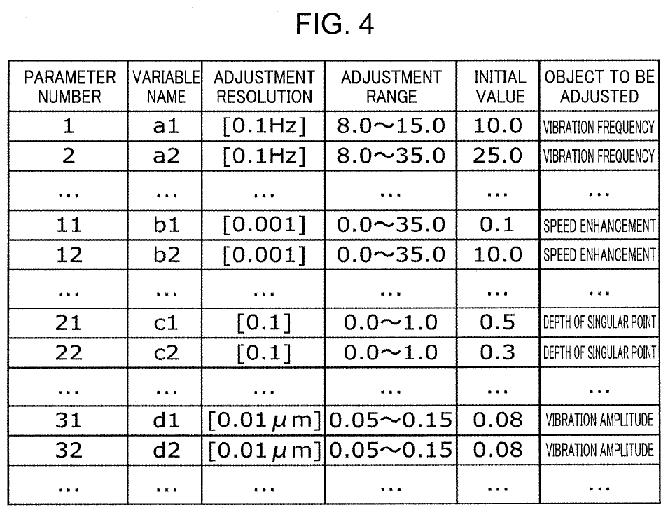

FIG. 4 is a data configuration diagram illustrating one example of the control parameters stored in the memory 21.

As illustrated in FIG. 4, the control parameters stored in the memory 21 include parameters a1 and a2 for adjusting a vibration frequency of the object to be driven 24, parameters b1 and b2 for adjusting an increase in the speed the object to be driven 24, parameters c1 and c2 for adjusting the depth of a singular point in the vibration characteristic of the object to be driven 24, parameters d1 and d2 for adjusting the vibration amplitude of the object to be driven 24, and the like.

In general, the control parameters include parameters having a trade-off relationship with each other, such as the parameters b1 and b2 for adjusting the increase in the speed, the parameters c1 and c2 for adjusting the depth of the singular point in the vibration characteristic, and the parameters d1 and d2 for adjusting the vibration amplitude.

Returning again to FIGS. 1 and 2, the description about the control parameter generation system 1 will be continued.

The sensor 30 measures the position of the object to be driven 24 in the production device 20 that performs at least one operation among N operations along the time series. Then, measurement data indicating the measured position corresponding to each of at least one operation is output to the control parameter generation device 10.

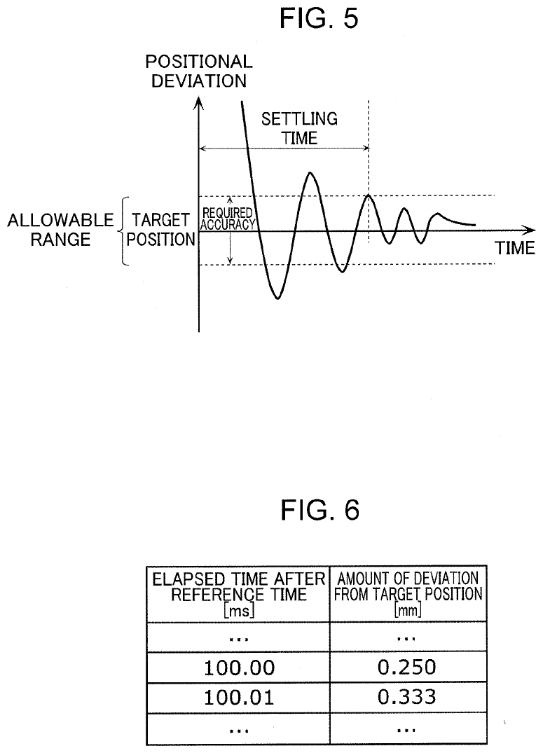

FIG. 5 is a schematic diagram illustrating one example of transition of a positional deviation of the object to be driven 24 with respect to a target position when the production device 20 drives the object to be driven 24 to the target position.

In FIG. 5, the horizontal axis represents time, and the vertical axis represents the positional deviation of the object to be driven 24 with respect to the target position.

As illustrated in FIG. 5, in this specification, the allowable range means a range in which the positional deviation from the target position is within required accuracy.

Further, as illustrated in FIG. 5, in this specification, the time (hereinafter, also referred to as “settling time”) of arrival at the allowable position that can be evaluated as having arrived at the target position means the time at which the object to be driven 24 finally arrives at the allowable range in a case where the object to be driven has not deviated from the allowable range again after arriving at the allowable range.

As illustrated in FIG. 5, in this specification, the settling time means a time from the start of stopping of the object to be driven 24 based on the command for setting the position of the object to be driven 24 to the target position until the object to be driven 24 arrives at the allowable position where the object to be driven can be evaluated to arrive at the target position. That is, the settling time means a time from the stop start time to the settling time, or a time from the start of transfer of the object to be driven 24 based on the command for setting the position of the object to be driven 24 to the target position until the object to be driven 24 arrives at the allowable position where it can be evaluated to arrive at the target position, that is, a time from the transfer start time to the settling time.

FIG. 6 is a data configuration diagram illustrating one example of measurement data output from the sensor 30.

As illustrated in FIG. 6, the measurement data is, for example, data in which an elapsed time [ms] after a reference time and a deviation amount [mm] from the target position are associated on a one-to-one basis. Here, the reference time is a stop start time of the object to be driven 24 based on the command for setting the position of the object to be driven 24 to the target position, or a transfer start time of the object to be driven 24 based on the command for setting the position of the object to be driven 24 to the target position.

Returning again to FIGS. 1 and 2, the description about the control parameter generation system 1 will be continued.

The control parameter generation device 10 generates control parameters used for the production device 20.

The control parameter generation device 10 is implemented, for example, in a computer device including a processor, a memory, and an input-output interface, by the processor executing a program stored in the memory. Such a computer device is, for example, a personal computer.

As illustrated in FIG. 2, the control parameter generation device 10 includes an information processing unit 41 such as a processor, a storage unit 42 such as a memory, an input unit 44 such as a mouse or a keyboard, a display unit 17 such as a liquid crystal display or an organic electroluminescent (EL) display, and a communication unit 43 such as a communication module.

As functions implemented by the processor executing the program read from a recording medium such as a computer-readable read only memory (ROM), the information processing unit 41 includes a determination unit 13, a selection unit 19, a control unit 18, an acquisition unit 11, an output unit 12, an operation reception unit 15, an image generation unit 16, and a generation unit 14. That is, the program is a program for causing the information processing unit 41 as an information processing device mounted on the control parameter generation device 10 to function as the determination unit 13 (determination means), the selection unit 19 (selection means), the control unit 18 (control means), the acquisition unit 11 (acquisition means), the output unit 12 (output means), the operation reception unit 15 (operation reception means), the image generation unit 16 (image generation means), and the generation unit 14 (generation means).

The selection unit 19 selects a representative operation including at least one operation among all the operations that can be performed by the production device 20.

The control unit 18 causes the production device 20 to perform the representative operation selected by the selection unit 19 or all the operations.

The acquisition unit 11 acquires measurement data that is output from the sensor 30 and correspond to one or more operations performed by the production device 20.

For each of the one or more operations acquired by the acquisition unit 11, based on the measurement data corresponding to the operations, the determination unit 13 determines, for the operations, the time from the start of stop or start of transfer of the object to be driven 24 in response to the command for setting the position of the object to be driven 24 to the target position until the object to be driven arrives at an allowable position where the arrival at the target position can be evaluated, that is, a settling time. That is, the determination unit 13 functions as a calculation unit that calculates an evaluation value of an evaluation index (settling time in the example of the present embodiment) based on the measurement data acquired by the acquisition unit 11.

The generation unit 14 generates update control parameters by updating the control parameters in the optimization processing so as to shorten at least the longest settling time among one or more settling times that each correspond to one or more operations acquired by the acquisition unit 11 and that are determined by the determination unit 13. That is, the generation unit 14 functions as an updating unit that updates the control parameters based on the evaluation value calculated by the determination unit 13 as the calculation unit.

That is, the generation unit 14 optimizes at least the longest settling time among the one or more settling times as the evaluation value to be optimized.

Note that the evaluation value may be an average value of the settling times or an average value of P (P is a value smaller than L) longest settling times among L settling times.

As illustrated in FIG. 2, the generation unit 14 includes an optimization algorithm 140 for optimizing the control parameters so as to shorten the settling time. Then, the generation unit 14 uses the optimization algorithm 140 to execute optimization processing for shortening at least the longest settling time among the one or more settling times determined by the determination unit 13.

The optimization algorithm 140 may be, for example, a known algorithm, such as a Bayesian optimization algorithm, an evolutionary strategy algorithm (CMA-ES), or a genetic algorithm (GA). Further, the optimization processing for shortening the settling time using the optimization algorithm 140 may be, for example, known processing executed using the above-described known algorithm.

For example, the generation unit 14 may generate the update control parameters by executing the optimization processing once, or may generate the update control parameters by repeatedly executing the optimization processing until an optimization processing end condition is satisfied.

Here, the optimization processing end condition is, for example, a period of time during which the optimization processing is repeated. In this case, the generation unit 14 repeats the optimization processing for a predetermined period of time.

Further, the optimization processing end condition is, for example, a number of times the optimization processing is repeated. In this case, the generation unit 14 repeats the optimization processing a predetermined number of times.

Further, the optimization processing end condition is, for example, a time corresponding to the one or more settling times. In this case, the generation unit 14 repeats the optimization processing until the one or more settling times become equal to or shorter than a predetermined time.

The output unit 12 outputs the control parameters generated by the generation unit 14 to the production device 20 in order to store the control parameters in the memory 21.

The operation reception unit 15 receives an operation for inputting the setting information or the like from the input unit 44 to the control parameter generation device 10, the operation being performed by a user using the control parameter generation system 1.

The display unit 17 displays an image to be provided to the user who uses the control parameter generation system 1. Note that a mode of information notification to the user is not limited to image display, and may be voice output or the like.

The image generation unit 16 generates an image to be displayed by the display unit 17.

### <Operation>

An operation performed by the control parameter generation system 1 having the above configuration will be described below.

The control parameter generation system 1 executes first control parameter generation processing, condition acquisition processing, and representative operation designation processing.

Hereinafter, the above processing will be sequentially described with reference to the drawings.

First, the first control parameter generation processing will be described.

The first control parameter generation processing is processing for generating control parameters used for the production device 20.

The first control parameter generation processing is started, for example, by the user of the control parameter generation system 1 performing an operation for starting the first control parameter generation processing through the operation reception unit 15.

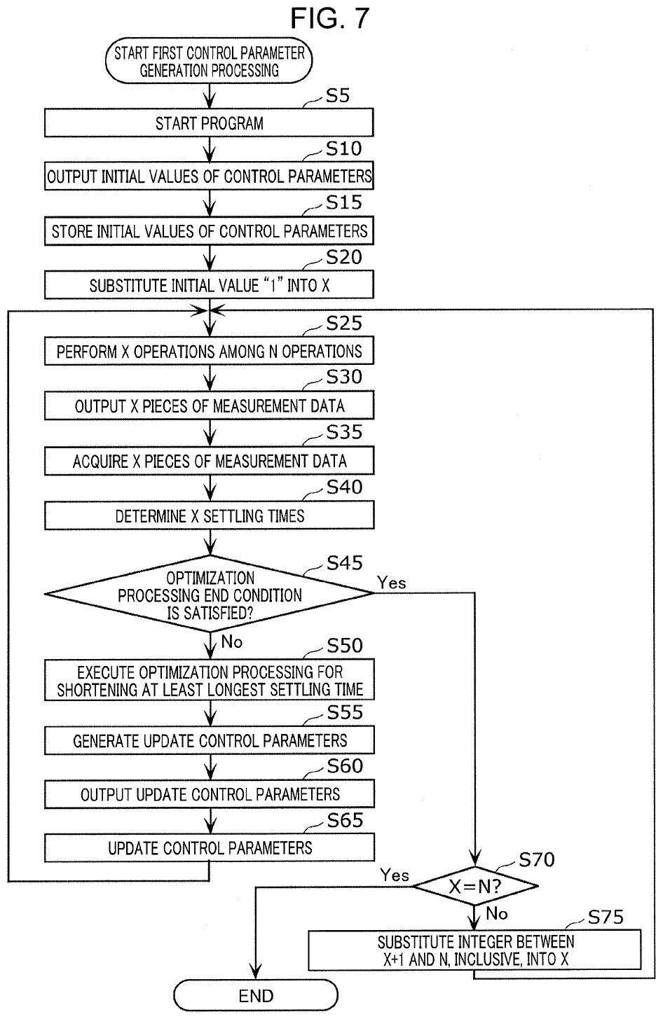

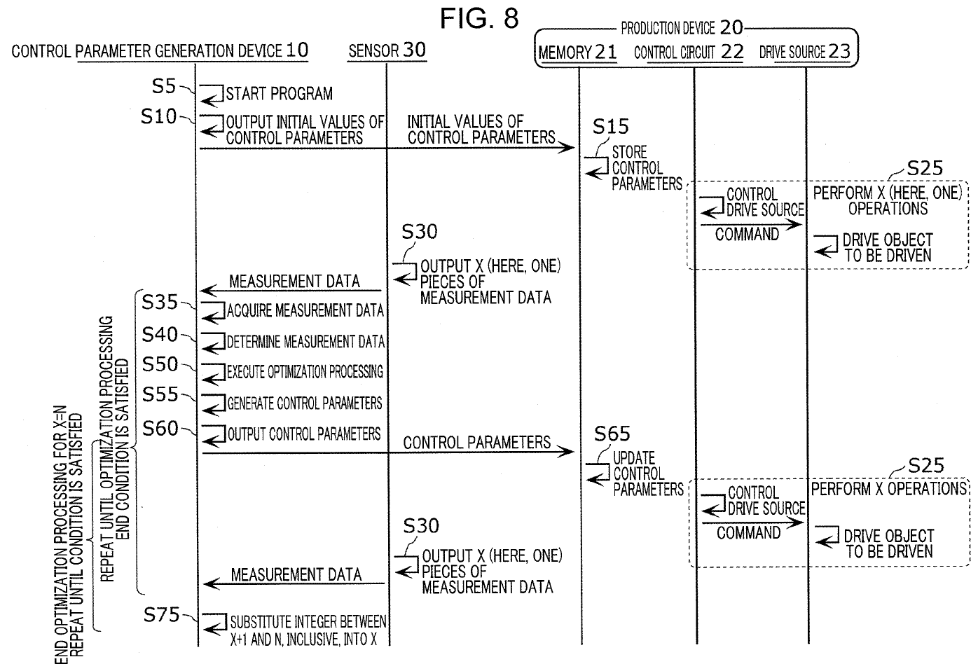

FIG. 7 is a flowchart of the first control parameter generation processing, and FIG. 8 is a sequence diagram of the first control parameter generation processing.

As illustrated in FIGS. 7 and 8, when the first control parameter generation processing is started, the operation reception unit 15 starts a predetermined program for executing the first control parameter generation processing (step S5).

When the predetermined program is started, the output unit 12 outputs initial values of the control parameters to the memory 21 (step S10). At this time, the output unit 12 may output, for example, initial value of control parameters including predetermined values, may output, for example, initial values of control parameter including values designated by the user, or may output, for example, initial values of control parameters including values calculated with a calculation method designated by the user.

When the control parameters are output from the output unit 12, the memory 21 stores the control parameters output from the output unit 12 (step S15).

Then, the control parameter generation device 10 substitutes initial value 1 into an int X (step S20).

Here, the description will be given assuming that the initial value to be substituted into int X is 1, but the initial value is not necessarily limited to 1 as long as it may be an integer between 1 and N−1, inclusive. For example, the initial value to be substituted into int X may be designated by the user.

Next, after the selection unit 19 selects representative operations including X operations, the production device 20 performs X operations among N operations under the control made by the control unit 18 (step S25). Here, the X operations selected by the selection unit 19 may be, for example, operations designated by the user, predetermined operations determined in advance, or operations actively designated with a designation method designated by the user. In a case where the user designates X operations to be performed by the production device 20, for example, the designation is achieved by executing representative operation designation processing described later.

When the production device 20 performs the X operations, the sensor 30 outputs X pieces of measurement data respectively corresponding to the X operations to the control parameter generation device 10 (step S30).

The acquisition unit 11 then acquires the X pieces of measurement data respectively corresponding to the X operations from the sensor 30 (step S35).

When the acquisition unit 11 acquires the X pieces of measurement data, the determination unit 13 determines the settling time for each of the X pieces of measurement data (step S40).

When the determination unit 13 determines the X settling times, the generation unit 14 checks whether the optimization processing end condition is satisfied (step S45).

In the processing of step S45, when the optimization processing end condition is not satisfied (step S45: No), the generation unit 14 executes the optimization processing to shorten at least the longest settling time among the X settling times (step S50). Preferably, the control parameter optimization processing is executed so that all of the X settling times are equal to or less than a target value. The generation unit 14 then generates update control parameters optimized to shorten at least the longest settling time among the X settling times in the optimization processing (step S55).

The output unit 12 outputs the generated update control parameters to the production device 20 in order to store these parameters in the memory 21 (step S60).

The memory 21 acquires the output control parameters and updates control parameters to be stored using the acquired control parameters (step S65).

When the processing of step S65 ends, the first control parameter generation processing proceeds to the processing of step S25 again.

In the processing of step S45, in a case where the optimization processing end condition is satisfied (step S45: Yes), the control parameter generation device 10 checks whether the value of int X is equal to N (step S70).

In the processing of step S70, in a case where the value of int X is not equal to N (step S70: No), that is, in a case where the value of int X is smaller than N, the control parameter generation device 10 substitutes an integer between X+1 and N, inclusive, into int X (step S75).

When the processing of step S75 ends, the first control parameter generation processing proceeds to the processing of step S25 again.

In the processing of step S70, in a case where the value int X is equal to N (step S70: Yes), the first control parameter generation processing ends.

Note that when the determination unit 13 determines the X settling times in the processing of step S40, the image generation unit 16 may generate an image indicating the status of the optimization processing at the present time, and the display unit 17 may output the image generated by the image generation unit 16.

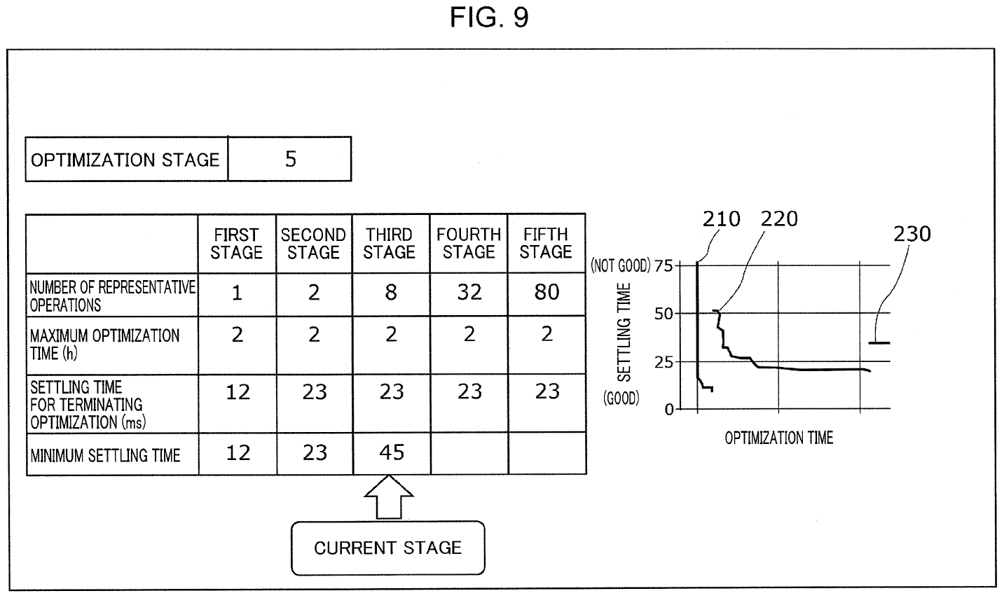

FIG. 9 is a schematic diagram illustrating one example of the above-described image displayed by the display unit 17.

In FIG. 9, the display “5” in a right-side column of a column “optimization stage” indicates that the number of times an integer is substituted into int X in the first control parameter generation processing currently being executed is 5 times, that is, the first control parameter generation processing that currently being executed is processing for repeating loop processing from the processing of step S25 via the processing of step S45: Yes and the processing of step S70: No and returning to the processing of step S25 four times.

The display “1” in the column “the number of representative operations” in “the first stage” indicates that integer “1” is substituted into int X at the first time, that is, in the processing of step S20.

The display “2” in the column “the number of representative operations” in “the second stage” indicates that integer “2” is substituted into int X at the second time, that is, in the processing of step S75 executed at the first time in the loop processing.

The display “8” in the column “the number of representative operations” in “the third stage” indicates that integer “8” is substituted into int X at the third time, that is, in the processing of step S75 executed at the second time in the loop processing.

The display “32” in the column “the number of representative operations” in “the fourth stage” indicates that integer “32” is substituted into int X at the fourth time, that is, in the processing of step S75 executed at the third time in the loop processing.

The display “80” in the column “the number of representative operations” in “the fifth stage” indicates that integer “80” is substituted into int X at the fifth time, that is, in the processing of step S75 executed at the fourth time (namely, at the last time) in the loop processing.

The display “2” in a column “maximum optimization time (h)” in “the first stage” to “fifth stage” indicates that the optimization processing end condition in each stage includes a condition such that the predetermined period of time during which the optimization processing (that is, the processing of step S50) is repeated is two hours, that is, a condition such that the upper limit of repeating the optimization processing in each stage is two hours.

The display “12” in the column “the settling time (ms) for terminating optimization” in “the first stage” indicates that the optimization processing end condition in the first stage includes a condition such that the settling time for repeating the optimization processing is 12 ms, that is, a condition such that an upper limit for repeating the optimization processing in the first stage is until the settling time determined in the processing of step S40 becomes 12 ms.

The display “23” in the column “the settling time (ms) for terminating optimization” in “the second stage” to “the fifth stage” indicates that the optimization processing end condition in each of the second stage to the fifth stage includes a condition such that that the settling time for repeating the optimization processing is 23 ms, that is, a condition such that that an upper limit for repeating the optimization processing in each of the second stage to the fifth stage is until the X settling times determined in the processing of step S40 becomes 23 ms or less.

The display “12” in the column “minimum settling time” in “the first stage” indicates that a minimum value of the settling time determined in the first stage is 12 ms.

The display “23” in the column “minimum settling time” in “the second stage” indicates that a minimum value of the settling time determined in the second stage is 23 ms.

The display “45” in the column “minimum settling time” in “the third stage” indicates that a minimum value of the settling time determined in the third stage is 45 ms at present.

Blank portions in the columns “minimum settling time” in “the fourth stage” and “the fifth stage” indicate that the settling time is not determined in the fourth stage and the fifth stage.

A line graph 210 on a right graph indicates the time transition of the settling time determined in the first stage, a line graph 220 indicates the time transition of the settling time determined in the second stage, and a line graph 230 indicates the time transition of the settling time determined in the third stage.

Next, the condition acquisition processing will be described.

The condition acquisition processing is processing for acquiring a condition at a time of executing the first control parameter generation processing.

Here, the condition acquisition processing will be described as processing for acquiring the number of times of substituting an integer into int X, a numerical value at a time of substituting an integer into int X, and the optimization processing end condition used for the processing in step S65 in the first control parameter generation processing. The optimization processing end condition is such that the optimization processing is executed for a predetermined period of time, or the X settling times determined in the processing of step S40 are equal to or less than a predetermined time.

The condition acquisition processing is started, for example, by the user of the control parameter generation system 1 performing an operation for starting the condition acquisition processing through the operation reception unit 15.

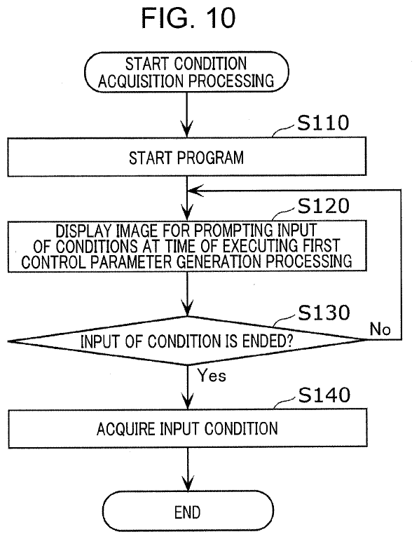

FIG. 10 is a flowchart of the condition acquisition processing.

As illustrated in FIG. 10, when the condition acquisition processing is started, the operation reception unit 15 starts a predetermined program for executing the condition acquisition processing (step S110).

When the predetermined program is started, the image generation unit 16 generates an image for prompting the user of the control parameter generation system 1 to input conditions for executing the first control parameter generation processing. Then, the display unit 17 displays the generated image (step S120).

When the image is displayed, the operation reception unit 15 waits until the user finishes inputting conditions for executing the first control parameter generation processing (step S130: No, repeat loop of step S120).

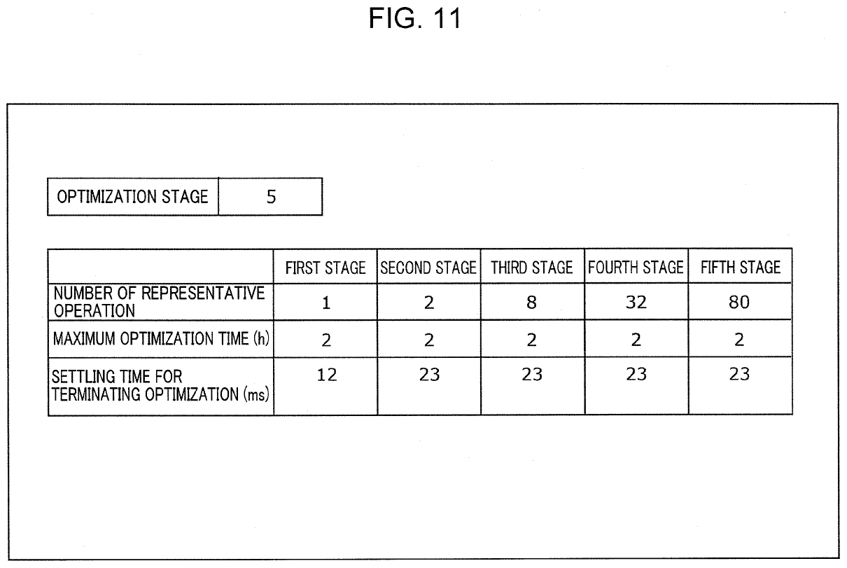

FIG. 11 is a schematic diagram illustrating one example of the above-described image displayed by the display unit 17. FIG. 11 illustrates one example of the drawing in a state where a condition for executing the first control parameter generation processing is input by the user.

In FIG. 11, the display “5” in the right column of the column “optimization stage” indicates that the number of times of substituting an integer into int X in the first control parameter generation processing is 5, the integer being input by the user.

The display “1” in the column “the number of representative operations” in “the first stage” indicates that the integer to be substituted into int X at the first time is “1”, the integer being input by the user or being set as a default. Note that, here, as described above, the initial value to be substituted into int X is determined to be the default “1”, and thus, the user does not have to input the initial value.

The display “2” in the column “the number of representative operations” in “the second stage” indicates that the integer to be substituted into int X at the second time is “2”, the integer being input by the user.

The display “8” in the column “the number of representative operations” in “the third stage” indicates that the integer to be substituted into int X at the third time is “8”, the integer being input by the user.

The display “32” in the column “the number of representative operations” in “the fourth stage” indicates that the integer to be substituted into int X at the fourth time is “32, the integer being input by the user.

The display “80” in the column “the number of representative operations” in “the fifth stage” indicates that the integer to be substituted into int X at the fifth time is “80”, the integer being input by the user.

The display “2” in the column “maximum optimization time (h)” in each of “the first stage” to “the fifth stage” indicates that the predetermined period of time in the optimization condition in each stage is 2 h, the predetermined period of time being input by the user. That is, the display “2” indicates that a condition such that the upper limit of repeating the optimization processing in each stage is up to 2 hours is input by the user as the optimization processing end condition in each stage.

The display “12” in the column “the settling time (ms) for terminating optimization” in the “first stage” indicates that the predetermined time in the optimization processing end condition in the first stage is 12 ms, the predetermined time being input by the user. That is, the above display indicates that a condition such that the upper limit of repeating the optimization processing in the first stage is until the settling time determined in the processing of step S40 becomes 12 ms is input by the user as the optimization processing end condition in the first stage.

The display “23” in the column “the settling time (ms) for terminating optimization” in each of the “second stage” to the “fifth stage” indicates that the predetermined period of time in the optimization processing end condition in each of the second stage to the fifth stage is 23 ms, the predetermined period of time being input by the user. That is, the above display indicates that a condition such that the upper limit of repeating the optimization processing in each of the second stage to the fifth stage is until the settling time determined in the processing of step S40 becomes 23 ms is input by the user as the optimization processing end condition in each of the first stage to the fifth stage.

Returning to FIG. 10 again, the description about the condition acquisition processing will be continued.

When the input of the condition for executing the first control parameter generation processing by the user is ended in the processing of step S130 (step S130: Yes), the operation reception unit 15 acquires the condition for executing the first control parameter generation processing, the condition being input by the user (step S140).

When the processing in step S140 ends, the condition acquisition processing ends.

Next, the representative operation designation processing will be described.

The representative operation designation processing is processing for designating each of the X operations to be executed in the respective stages when the first control parameter generation processing is executed. Hereinafter, the X operations to be executed in the respective stages are also referred to as “representative operations” in the stages.

The representative operation designation processing is started, for example, by the user of the control parameter generation system 1 performing an operation for starting the representative operation designation processing through the operation reception unit 15.

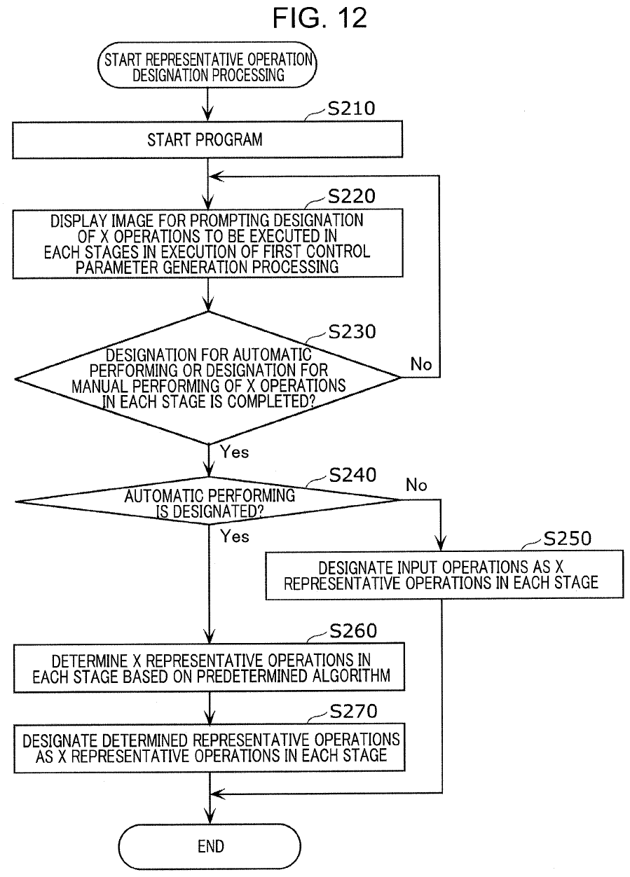

FIG. 12 is a flowchart of the representative operation designation processing.

As illustrated in FIG. 12, when the representative operation designation processing is started, the operation reception unit 15 starts a predetermined program for executing the representative operation designation processing (step S210).

When the predetermined program is started, the image generation unit 16 generates an image for prompting the user of the control parameter generation system 1 to designate the X operations to be executed in the respective stages when the first control parameter generation processing is executed. Then, the display unit 17 displays the generated image (step S220).

When the image is displayed, the operation reception unit 15 waits until the user completes designation to automatically perform the X operations in each stage when executing the first control parameter generation processing or designation to manually perform the X operations in each stage when executing the first control parameter generation processing (repeat the loop processing in step S230: No and in step S220).

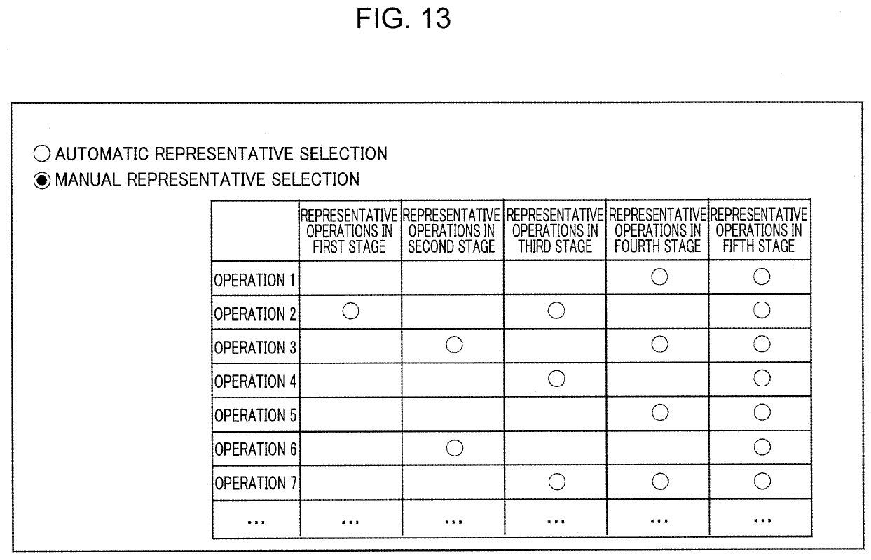

FIG. 13 is a schematic diagram illustrating one example of the above-described image displayed by the display unit 17. FIG. 13 illustrates one example of (1) the designation by the user to manually designate the X operations to be performed in each stage, and the above drawing in a state where (2) the user has manually designated the X operations to be performed in each stage.

In FIG. 13, a black circle on the left side of the “manual representative selection” indicates that the user has performed a designation to manually designate the X operations to be performed in each stage. On the other hand, in a case where the user has performed designation to automatically designate the X operations to be performed in each stag, the black circle is displayed on the left side of the “automatic representative selection”.

A white circle on the left side of “representative operation in the first-stage” indicates that corresponding operations (the operations designated by the operation names at the left end of the table, the same applies hereinafter) have been designated by the user as the X operations to be performed in the first stage.

Similarly, the white circles in the columns “representative operation in the second stage” to “representative operation in the fifth stage” indicate that the corresponding operations have been designated by the user as the X operations to be performed in the second to fifth stages.

Returning to FIG. 12 again, the description about the condition acquisition processing will be continued.

In the processing of step S230, when the user completes the designation to automatically perform the X operations to be performed in each stage in the execution of the first control parameter generation processing or the designation to manually perform the X operations to be performed in each stage in the execution of the first control parameter generation processing (step S230: Yes), the operation reception unit 15 checks whether, in the execution of the first control parameter generation processing, the designation to automatically perform the X operations to be performed in each stage has been performed by the user (step S240).

In the processing of step S240, when the user has not designated to automatically perform the X operations to be performed in each stage in the execution of the first control parameter generation processing (step S240: No), that is, when the user has designated to manually perform the X operations to be performed in each stage in the execution of the first control parameter generation processing, the operation reception unit 15 designates the X operations to be executed in each stage designated by the user as the X representative operations in each stage (step S250).

In the processing of step S240, when the user has designated to automatically perform the X operations to be performed in each stage in the execution of the first control parameter generation processing (step S240: Yes), the operation reception unit 15 determines the X operations to be performed in each stage in the execution of the first control parameter generation processing, based on a predetermined algorithm (step S260).

For example, the operation reception unit 15 may determine the predetermined operations as the X operations to be performed in each stage, or may determine operations satisfying a predetermined condition as the X operations to be performed in each stage.

When the processing of step S260 ends, the operation reception unit 15 designates the X operations to be performed in each stage, the X operations being determined in the processing of step S260, as the X representative operations in each stage (step S270).

In a case where the processing of step S250 ends and in a case where the processing of step S270 ends, the representative operation designation processing ends.

### <Discussion>

The control parameter generation device 10 having the above configuration does not directly searches for appropriate control parameters for all the N (for example, 80) operations to be performed by the production device 20, first searches for appropriate control parameters for one or some (for example, one) of the N operations, searches for appropriate control parameters based on a previous search result while gradually increasing the number of target operations, and finally searches for appropriate control parameters for all the N operations to generate the appropriate control parameters.

Therefore, the control parameter generation device 10 having the above configuration can generate control parameters more efficiently and more reliably than generating the appropriate control parameters by directly searching for the appropriate control parameters for all the N operations to be performed by the production device 20.

As described above, the control parameter generation device 10 having the above configuration can efficiently generate appropriate control parameters.

In addition, the inventors conducted an experiment using a production device simulation model by comparing the settling time achieved when control parameters are generated by using the conventional method for generating appropriate control parameters by directly searching for the appropriate control parameters for all the N operations to be performed by the production device 20 with the settling time achieved when the control parameters used for the production device 20 are generated by using the control parameter generation device 10.

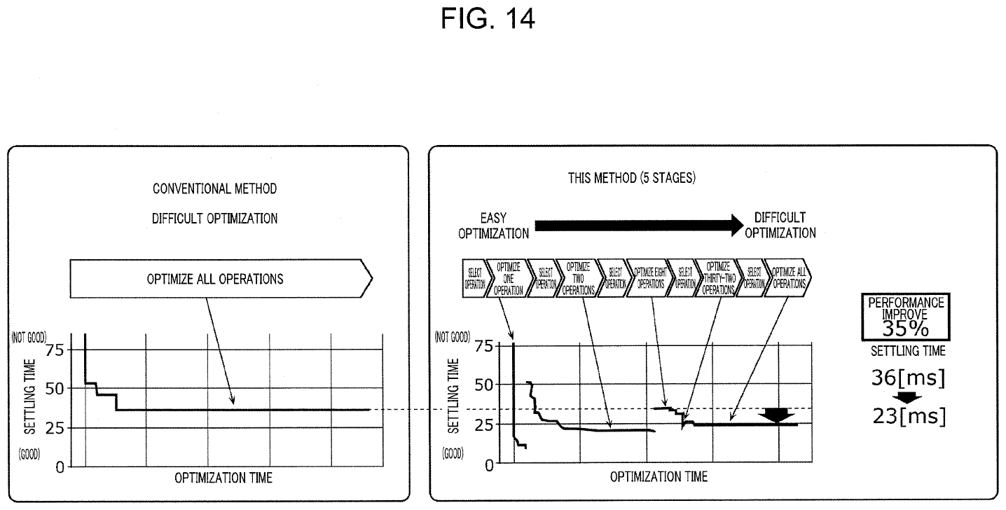

FIG. 14 is a schematic diagram illustrating an experimental result.

As illustrated in FIG. 14, the settling time achieved when the control parameters are generated with the conventional method is 36 [ms], and the settling time achieved when the control parameters are generated by using the control parameter generation device 10 by using the control parameter generation device 10 is 23 [ms].

As described above, the inventors verified through this experiment that the settling time can be reduced by about 35% when the control parameter generation device 10 generates control parameters as compared with use of the conventional method.

### SECOND EMBODIMENT

Hereinafter, a control parameter generation system according to a second embodiment will be described. This system is configured by partially changing the configuration of the control parameter generation system 1 according to the first embodiment.

The control parameter generation system 1 according to the first embodiment is one example of the configuration where the optimization processing executed by the control parameter generation device 10 is processing for shortening the settling time. On the other hand, the control parameter generation system according to the second embodiment is one example of a configuration where the optimization processing executed by a control parameter generation device according to the second embodiment is processing for reducing an extent of deviation, described later.

Here, in the control parameter generation system according to the second embodiment, components similar to those of the control parameter generation system 1 have already been described and are denoted by the same reference numerals, detailed description thereof is omitted, and differences from the control parameter generation system 1 will be mainly described.

### <Configuration>

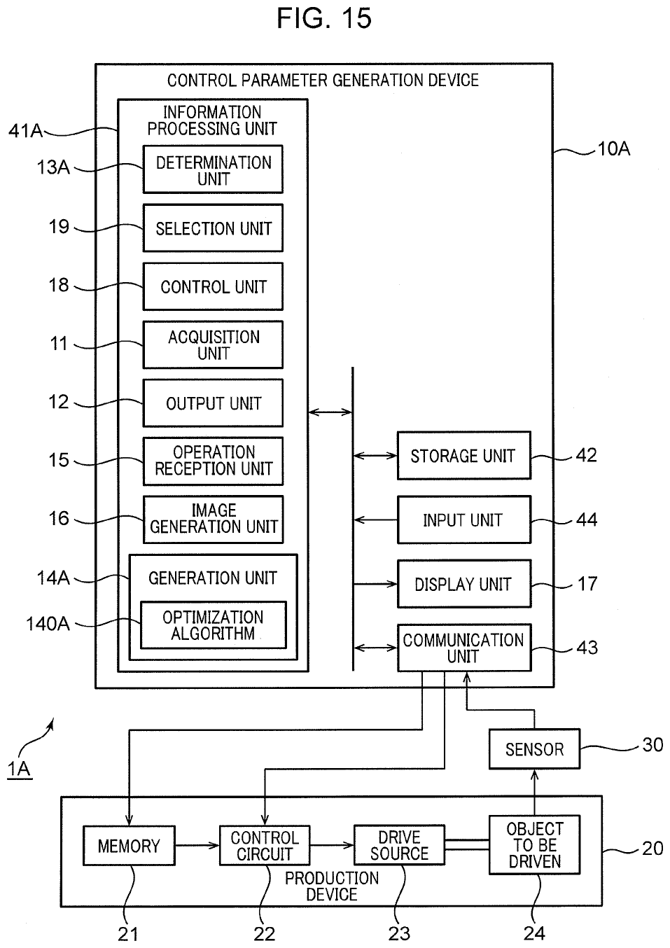

FIG. 15 is a block diagram illustrating a configuration of a control parameter generation system 1A according to the second embodiment.

As illustrated in FIG. 15, the control parameter generation system 1A is configured by changing the control parameter generation device 10 of the control parameter generation system 1 according to the first embodiment to a control parameter generation device 10A. In addition, the control parameter generation device 10A is configured so that the determination unit 13, the generation unit 14, and the optimization algorithm 140 of the control parameter generation device 10 are changed respectively to a determination unit 13A, a generation unit 14A, and an optimization algorithm 140A.

For each of the one or more operations acquired by the acquisition unit 11, in a case where a time zone in which the object to be driven 24 does not fall within an allowable range allowed from the target position when the position of the object to be driven 24 is set to the target position occurs for the operations based on the measurement data corresponding to the operations, the determination unit 13A determines an extent to which the object to be driven does not fall within the allowable range in the time zone, that is, an extent of deviation. That is, while the evaluation index in the first embodiment is the settling time until the positional deviation between the position of the object to be driven 24 and the target position converges within the allowable range, the evaluation index in the second embodiment is an integrated value of a deviation time during which the positional deviation between the position of the object to be driven 24 and the target position deviates from the allowable range or a positional deviation amount.

Hereinafter, a specific example of the extent of deviation determined by the determination unit 13A will be described with reference to the drawings.

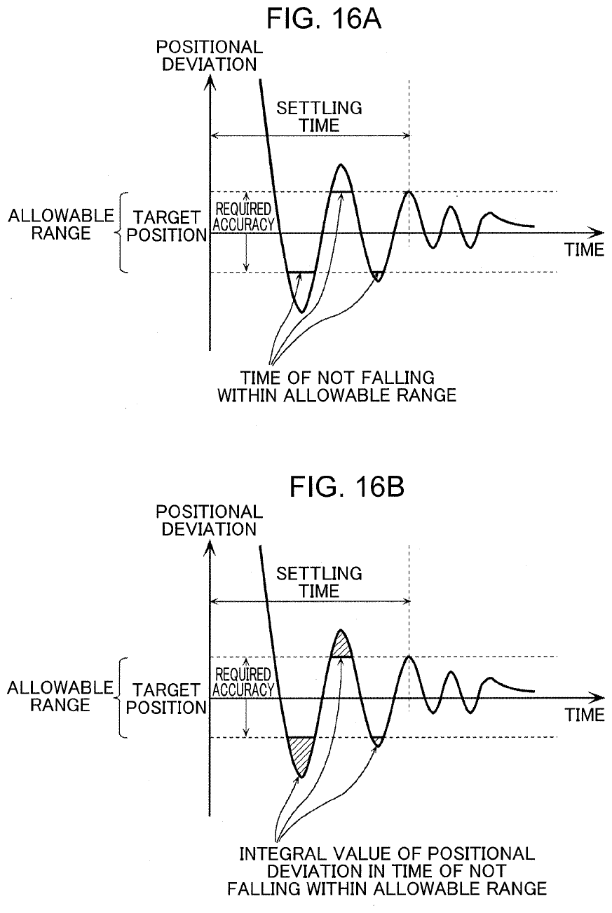

FIGS. 16A and 16B are schematic diagrams illustrating one example of transition of the positional deviation of the object to be driven 24 with respect to the target position when the production device 20 drives the object to be driven 24 to the target position.

In FIGS. 16A and 16B, the horizontal axis represents time, and the vertical axis represents the positional deviation of the object to be driven 24 with respect to the target position.

As illustrated in FIGS. 16A and 16B, when the position of the object to be driven 24 is set to the target position, the object to be driven 24 occasionally deviates from the allowable range once after the object to be driven 24 arrives at the allowable range.

In such a case, for example, as illustrated in FIG. 16A, the determination unit 13A determines the sum of the times during which the object to be driven 24 does not fall within the allowable range after the object to be driven 24 first arrives at the allowable range (hereinafter, also referred to as a “first sum”) as the extent of deviation.

Note that the determination unit 13A may calculate the first sum by adding a weight based the elapsed time from the start of stop or the start of transfer of the object to be driven 24. That is, the determination unit 13A may calculate the first sum by adding a larger weight (penalty) as the elapsed time from the start of stop or transfer of the object to be driven 24 is longer. This can reduce a relatively large fluctuation of the object to be driven 24 after a relatively long time has elapsed from the start of stop or transfer of the object to be driven 24.

Alternatively, in such a case, for example, as illustrated in FIG. 16B, the determination unit 13A determines the sum of the integrated values of the positional deviation at the times during which the object to be driven 24 does not fall within the allowable range after the object to be driven 24 first arrives at the allowable range (hereinafter, also referred to as a “second sum”) as the extent of deviation.

Note that in a case where the length of the time during which the object to be driven 24 does not fall within the allowable range is equal to or smaller than a threshold, the determination unit 13A may exclude this length of time from an addition target of the second sum. This can provide resistance to sensor noise generated in a short time.

Returning again to FIG. 15, the description about the control parameter generation system 1A will be continued.

The generation unit 14A generates update control parameters by updating the control parameters in the optimization processing so as to decrease at least the greatest extent of deviation among one or more extents of deviation that correspond respectively to one or more operations that are acquired by the acquisition unit 11 and are determined by the determination unit 13A.

As illustrated in FIG. 15, the generation unit 14A includes an optimization algorithm 140A for optimizing the control parameters so as to shorten the deviation time. Then, the generation unit 14A uses the optimization algorithm 140A to execute the optimization processing for decreasing at least the greatest extent of deviation among the one or more extents of deviation determined by the determination unit 13A.

The optimization algorithm 140A may be, for example, a known algorithm, such as a Bayesian optimization algorithm, an evolutionary strategy algorithm (CMA-ES), or a genetic algorithm (GA) as descried about the optimization algorithm 140 according to the first embodiment. Further, the optimization processing for decreasing the extent of deviation using the optimization algorithm 140A may be, for example, known processing executed using the above-described known algorithm.

Similarly to the generation unit 14 according to the first embodiment, the generation unit 14A may generate the update control parameters by executing the optimization processing once, or may generate the update control parameters by repeatedly executing the optimization processing until the optimization processing end condition is satisfied.

Here, the optimization processing end condition is, for example, a period of time during which the optimization processing is repeated. In this case, the generation unit 14A repeats the optimization processing for a predetermined period of time.

Further, the optimization processing end condition is, for example, a number of times the optimization processing is repeated. In this case, the generation unit 14A repeats the optimization processing predetermined number of times.

Further, the optimization processing end condition is, for example, an extent satisfied by the one or more extents of deviation. In this case, the generation unit 14A repeats the optimization processing until the one or more extents of deviation become equal to or lower than a predetermined extent.

### <Operation>

An operation performed by the control parameter generation system 1A having the above configuration will be described below.

Instead of the first control parameter generation processing according to the first embodiment, the control parameter generation system 1A executes second control parameter generation processing in which a part of the first control parameter generation processing is changed.

The second control parameter generation processing is processing for generating control parameters used for the production device 20 similarly to the first control parameter generation processing.

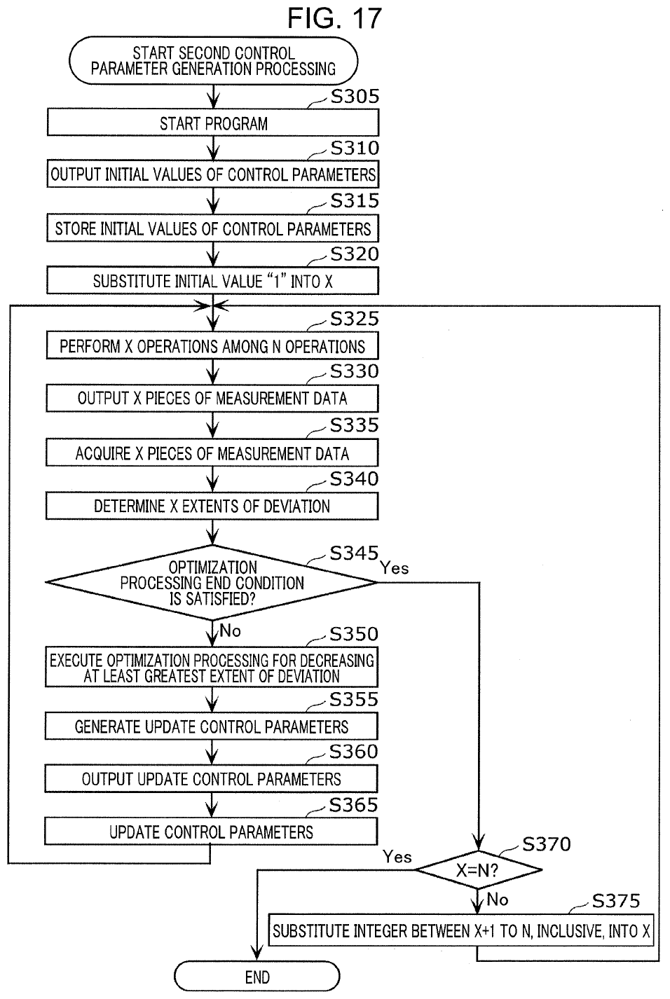

FIG. 17 is a flowchart of the second control parameter generation processing.

In the second control parameter generation processing, the processing of step S305 to step S335, the processing of step S345, and the processing of step S360 to step S375 are similar to the processing of step S5 to step S35, the processing of step S45, and the processing of step S60 to step S75 in the first control parameter generation processing. The control parameter generation device 10, the determination unit 13, and the generation unit 14 in the first control parameter generation processing are respectively read as the control parameter generation device 10A, the determination unit 13A, and the generation unit 14A, and the first control parameter generation processing is read as the second control parameter generation processing.

Therefore, here, the second control parameter generation processing will be described focusing on the processing in step S340, the processing in step S350, and the processing in step S355.

When the acquisition unit 11 acquires X pieces of measurement data in step S335, the determination unit 13A determines an extent of deviation for each of the X pieces of measurement data (step S340). The processing then proceeds to processing of step S345.

In the processing of step S345, when the optimization processing end condition is not satisfied (step S345: No), the generation unit 14A executes the optimization processing to decrease at least the greatest extent of deviation among the X extents of deviation (step S350). Preferably, the control parameter optimization processing is executed so that all of the X extents of deviation are equal to or less than a target value. The generation unit 14A then generates update control parameters optimized to decrease at least the greatest extent of deviation among the X extents of deviation in the optimization processing (step S355). The processing then proceeds to processing of step S345.

### <Discussion>

Similarly to the control parameter generation device 10, the control parameter generation device 10A having the above configuration does not directly search for appropriate control parameters for all the N (for example, 80) operations to be performed by the production device 20, but first searches for appropriate control parameters for one or some (for example, one) of the N operations, searches for appropriate control parameters based on a previous search result while gradually increasing the number of target operations, and finally searches for appropriate control parameters for all the N operations to generate the appropriate control parameters.

Therefore, the control parameter generation device 10A having the above configuration can, similarly to the control parameter generation device 10, generate the control parameters more efficiently and more reliably than generating the appropriate control parameters by directly searching for the appropriate control parameters for all the N operations to be performed by the production device 20.

As described above, the control parameter generation device 10A having the above configuration can efficiently generate appropriate control parameters similarly to the control parameter generation device 10.

### THIRD EMBODIMENT

Hereinafter, a control parameter generation system according to a third embodiment will be described. This system is configured by partially changing the operations of the control parameter generation system 1 according to the first embodiment.

### <Configuration>

The control parameter generation system according to the third embodiment has the hardware configuration identical to that of the control parameter generation system according to the first embodiment, but software to be executed is partially changed.

In the control parameter generation system according to the third embodiment, the components, which are similar to those of the control parameter generation system 1 and are denoted by the same reference numerals, have already been described. Thus, detailed description thereof will be omitted, and differences will be mainly described.

### <Operation>

Instead of the first control parameter generation processing and the representative operation designation processing according to the first embodiment, the control parameter generation system according to the third embodiment executes third control parameter generation processing in which the first control parameter generation processing is partially changed.

The third control parameter generation processing is processing for generating control parameters used for the production device 20 similarly to the first control parameter generation processing.

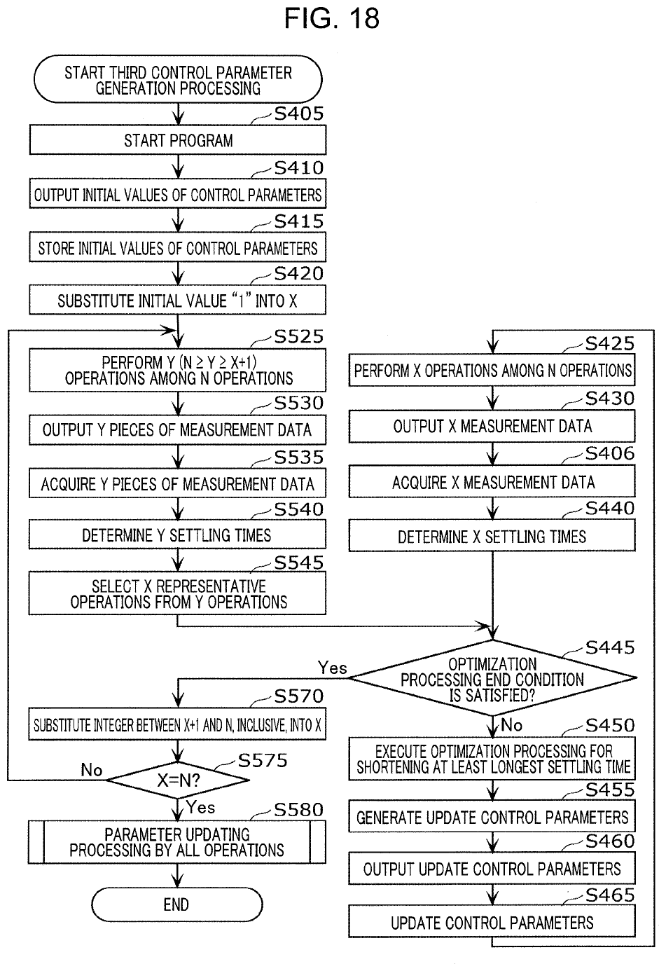

FIG. 18 is a flowchart of the third control parameter generation processing.

In the third control parameter generation processing, the processing of step S405 to the processing in step S465 are similar to the processing of step S5 to the processing of step S65 in the first control parameter generation processing. The first control parameter generation processing is read as the third control parameter generation processing.

Therefore, here, the third control parameter generation processing will be described focusing on the processing of step S525 to the processing of step S545, and the processing of step S570 to the processing of step S580.

When the processing of step S420 ends, the production device 20 performs Y operations (step S525). Here, Y is an integer between X+1 and N, inclusive.

When the production device 20 performs the Y operations, the sensor 30 outputs Y pieces of measurement data respectively corresponding to the Y operations to the control parameter generation device 10 (step S530).

The acquisition unit 11 then acquires the Y pieces of measurement data respectively corresponding to the Y operations from the sensor 30 (step S535).

When the acquisition unit 11 acquires the Y pieces of measurement data, the determination unit 13 determines a settling time for each of the Y pieces of measurement data (step S540).

When determining the settling time for each of the Y pieces of measurement data, the determination unit 13 selects X representative operations from the Y operations based on a predetermined algorithm (step S545).

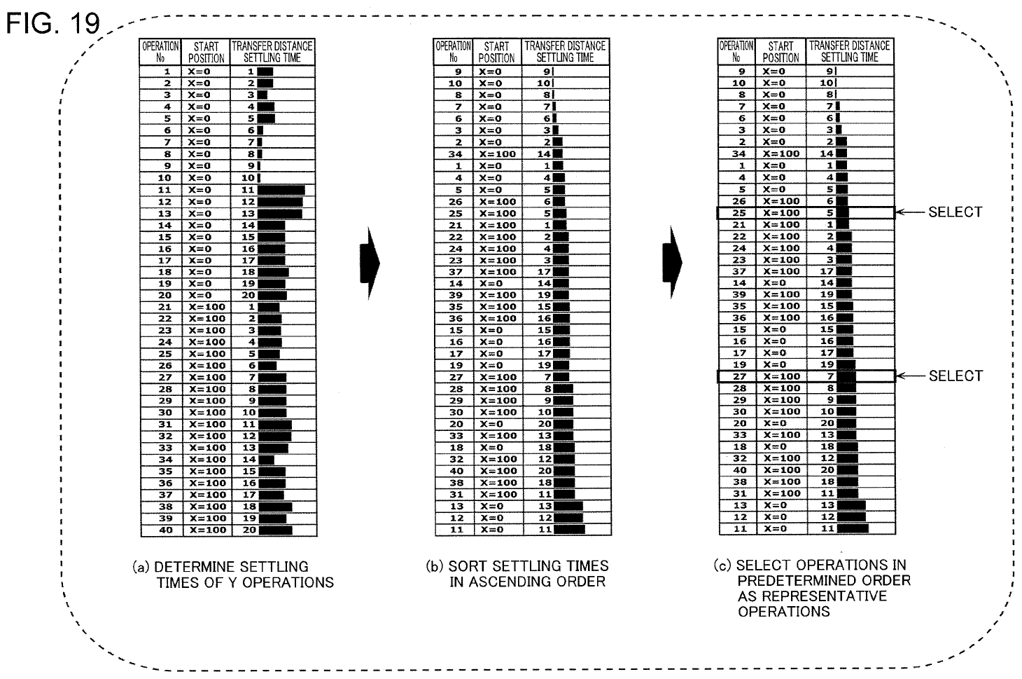

FIG. 19 is a schematic diagram illustrating one example of a state where the determination unit 13 selects the X representative operations from the Y operations. The example illustrated in FIG. 19 is an example in a case where Y is 40 and X is 2.

As illustrated in FIG. 19, for example, the determination unit 13 may sort the settling times of the Y operations determined in the processing of step S540 (see (a) of FIG. 19) in ascending order of the settling times (see (b) of FIG. 19), and select X operations located in predetermined order as the representative operations (see (c) of FIG. 19).

Returning again to FIG. 18, the description about the third control parameter generation processing will be continued.

When the processing of step S545 ends, the third control parameter generation processing proceeds to the processing of step S445.

In the processing of step S445, in a case where the optimization processing end condition is satisfied (step S445: Yes), the control parameter generation device 10 substitutes an integer between X+1 and N, inclusive, into int X (step S570). The control parameter generation device 10 then checks whether the value of int X is equal to N (step S575).

In the processing of step S575, in a case where the value of int X is not equal to N (step S575: No), that is, in a case where the value of int X is smaller than N, the third control parameter generation processing proceeds to step S525 again.

In the processing of step S575, in a case where the value of int X is equal to N (step S575: Yes), the control parameter generation system according to the third embodiment executes parameter updating processing by all the operations (step S580).

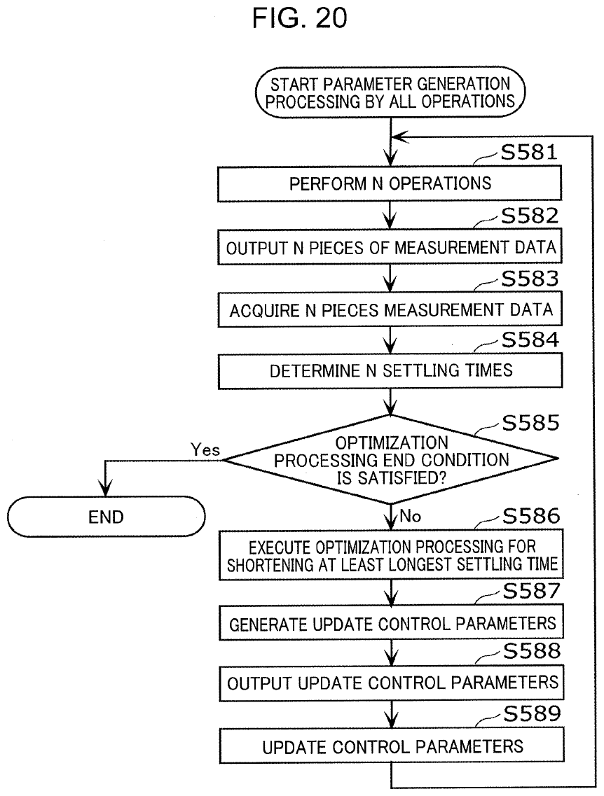

FIG. 20 is a flowchart of the parameter updating processing by all the operations.

As illustrated in FIG. 20, when the parameter updating processing by all the operations is started, the production device 20 performs the N operations under the control made by the control unit 18 (step S581).

When the production device 20 performs the N operations, the sensor 30 outputs N pieces of measurement data respectively corresponding to the N operations to the control parameter generation device 10 (step S582).

Thereafter, the acquisition unit 11 acquires the N pieces of measurement data respectively corresponding to the N operations from the sensor 30 (step S583).

When the acquisition unit 11 acquires the N pieces of measurement data, the determination unit 13 determines a settling time for each of the N pieces of measurement data (step S584).

When the determination unit 13 determines the N settling times, the generation unit 14 checks whether the optimization processing end condition is satisfied (step S585).

In the processing of step S585, in a case where the optimization processing end condition is not satisfied (step S585: No), the generation unit 14 executes the optimization processing to shorten at least the longest settling time among the N settling times (step S586). The generation unit 14 then generates update control parameters optimized to shorten at least the longest settling time among the N settling times in the optimization processing (step S587).

The output unit 12 outputs the generated update control parameters to the production device 20 in order to store these parameters in the memory 21 (step S588).

Thereafter, the memory 21 acquires the output control parameters and updates control parameters to be stored using the acquired control parameters (step S589).

When the processing of step S589 ends, the parameter updating processing by all the operations proceeds to the processing of step S581 again.

In the processing of step S585, in a case where the optimization processing end condition is satisfied (step S585: Yes), the parameter updating processing by all the operations ends.

Returning again to FIG. 18, the description about the third control parameter generation processing will be continued.

When the processing of step S580, that is, the parameter generation processing by all the operations ends, the third control parameter generation processing ends.

Note that, as described as, in the processing of step S545, the determination unit 13 sorts the determined Y settling times in ascending order, and selects X operations located in the predetermined order as the representative operations. However, the determination unit 13 is not necessarily limited to the example where the X operations are selected as the representative operations with this method. For example, the determination unit 13 may group the Y operations into X operation groups including operations similar to each other, and select an operation having the most characteristic settling time (for example, the longest settling time) in each operation group as the X representative operations.

### <Discussion>

Similarly to the control parameter generation device 10 according to the first embodiment, the control parameter generation device 10 according to the third embodiment that performs the above operations does not directly search for appropriate control parameters for all the N (for example, 80) operations to be performed by the production device 20, but first searches for appropriate control parameters for one or some (for example, one) of the N operations, searches for the appropriate control parameters based on a previous search result while gradually increasing the number of target operations, and finally searches for appropriate control parameters for all the N operations to generate the appropriate control parameters.

Therefore, similarly to the control parameter generation device 10 according to the first embodiment, the control parameter generation device 10 according to the third embodiment that performs the above operations can generate the control parameters more efficiently and more reliably than generating the appropriate control parameters by directly searching for the appropriate control parameters for all the N operations to be performed by the production device 20.

In such a manner, the control parameter generation device 10 according to the third embodiment that performs the above operations can efficiently generate appropriate control parameters similarly to the control parameter generation device 10.

### FOURTH EMBODIMENT

In the third embodiment, the parameter updating processing by all the N operations is executed in the final stage among a plurality of stages in the control parameter optimization processing as an evaluation operation for comprehensively evaluating the operations of the production device 20. However, the parameter updating processing may be executed at least once in a certain stage in the middle of the plurality of stages instead of the execution in the final stage or in addition to the execution in the final stage. The evaluation operation is performed in at least one of a period of time during which the representative operations in each stage are performed and in a transition period of time from a certain stage to the next stage. An accurate comprehensive evaluation can be made by causing the production device 20 to perform all the operations as the evaluation operation as in the third embodiment.

However, the evaluation operation is not limited to all the operations, and may be a differential operation between all the operation and the most recent representative operation with respect to the evaluation operation. The differential operation is a remaining operation obtained by excluding the operation included in the most recent representative operation from all the N operations. In the evaluation operation, the control unit 18 causes the production device 2 to execute only the differential operation. As the evaluation operation, by causing the production device 20 to perform the differential operation between all the operations and the most recent representative operation with respect to the evaluation operation, the efficiency of the evaluation operation can be improved while the accuracy of the comprehensive evaluation is being maintained. Alternatively, the evaluation operation is not limited to all the operations, and may be a prescribed operation prescribed from all the operations. For example, a plurality of predetermined operations is determined as the prescribed operations in descending order of an influence on the operation performance of the production device 20 among all the operations. In the evaluation operation, the control unit 18 causes the production device 2 to execute only the prescribed operations. As the evaluation operation, the efficiency of the evaluation operation can be improved by causing the production device 20 to operate a prescribed operation prescribed from all the operations.

The control unit 18 determines whether the evaluation result of the comprehensive evaluation satisfies a predetermined optimization end condition, and ends the control parameter optimization processing in a case where the evaluation result satisfies the optimization end condition. As the optimization end condition, a target value of the evaluation value regarding the evaluation operation may be set, an upper limit number of summing times of total values of the number of repetitions of the optimization processing in all the stages up to the current time may be set, or an upper limit time of the execution time of the optimization processing in all the stages up to the current time may be set. For example, in a case where the target value of the evaluation value is set as the optimization end condition, the control unit 18 determines that the optimization end condition is not satisfied when the evaluation value of the most recent evaluation operation exceeds a target value, but determines that the optimization end condition is satisfied when the evaluation value of the most recent evaluation operation is equal to or less than the target value. In a case where the evaluation result of the comprehensive evaluation by performing the evaluation operation satisfies the optimization end condition, the optimization processing ends even before the representative operations arrive at the final stage, and thus the time required for the optimization processing can be shortened.

### FIFTH EMBODIMENT

In each of the above embodiments, the number (X) of the representative operation is gradually increased as the stages of the control parameter optimization processing in the plurality of stages proceed, but the contents of the operations may be changed without increasing the number of operations.

For example, the number of representative operation may be fixed to four (X=4) in all the plurality of stages, and the selection unit 19 may reselect four representative operations each time the optimization processing end condition is satisfied and the stages proceed.

An example of a method for selecting the X representative operations in each stage by the selection unit 19 is as follows. Note that the selection method described below is not limited to the fifth embodiment in which the number of representative operations is fixed in all stages, and is also applicable to the first to fourth embodiments in which the number of the representative operation is changed in each stage.

As a first example, the selection unit 19 randomly selects X representative operations from all the N operations.

As a second example, the selection unit 19 selects the X representative operations according to a preset selectin rule. An example of the selection rule to be set may be a rule such that simpler operations are selected earlier and more complicated operations are selected later. That is, a rule may be such that the contents of the representative operations are made more complicated as the stage of the control parameter optimization processing proceeds.

As a third example, the selection unit 19 randomly arranges all of N operations, and every first X operations are selected as the representative operations. When the selection position comes to the end of the array, the selection unit 19 returns to the head of the same array and repeats the selection.

As a fourth example, the selection unit 19 randomly arranges all the N operations, and every first X operations are selected as the representative operations. When the selection position comes to the end of the array, the selection unit 19 randomly arranges all the N operations again, and selects the operations in order from the head.

As a fifth example, the selection unit 19 classifies all the N operations into X groups, and randomly selects one representative operation from each group.

As a sixth example, the selection unit 19 classifies all the N operations into X groups including operations similar to each other, based on a similarity such as a waveform of the measurement data or the evaluation value, randomly arranges a plurality of the operations belonging to each group, and sequentially selects first one operation from the array in order in each group as the representative operation.

As a seventh example, the selection unit 19 classifies all the N operations into X groups based on the above similarity, designates an operation having the greatest evaluation value (for example, the latest evaluation value) or the greatest past average value of the evaluation values among the plurality of operations belonging to each group as an operation to be improved, and selects X operations to be improved designated respectively for the X groups as the representative operations in the next control parameter optimization processing. The past average value may be an average value of the evaluation values over the entire period of time, or may be an average value of a predetermined number of the most recent evaluation values.

As an eighth example, the selection unit 19 classifies all the N operations into X groups based on a correlation similarity representing a change tendency of the plurality of evaluation values, designates an operation having the greatest evaluation value (for example, the latest evaluation value) or the greatest past average value of the evaluation values among the plurality of operations belonging to each group as the operation to be improved, and selects X operations to be improved designated respectively for the X groups as the representative operations in the next control parameter optimization processing. The past average value may be an average value of the evaluation values over the entire period of time, or may be an average value of a predetermined number of the most recent evaluation values.

Note that the selection unit 19 may perform the classification of the groups in the fifth to eighth examples a plurality of times. The selection unit 19 may perform the classification into the groups again each time the evaluation operation (step S71) described later is performed, may perform the classification into the groups again at regular time intervals, or may perform the classification into the groups again each time the evaluation result of the representative operation or the evaluation operation is improved by a certain threshold or more.

As a ninth example, the selection unit 19 randomly selects the X representative operations from all the N operations, and randomly selects the X representative operations from unselected operations excluding the selected operation in the next and subsequent operations. When the number of unselected operations is less than X, X representative operations are randomly selected again from all the N operations.

As a tenth example, the selection unit 19 randomly selects X representative operations from all the N operations, and in the next and subsequent operations, randomly selects X−1 representative operations among unselected operations excluding one operation having the worst evaluation value among the current X representative operations and the selected operation. When the number of unselected operations is less than X, X representative operations are randomly selected again from all the N operations.

Note that, in each of the plurality of stages of the control parameter optimization processing, X representative operations may be performed only once, or a plurality of sets each including X representative operations may be performed until the optimization processing end condition is satisfied.

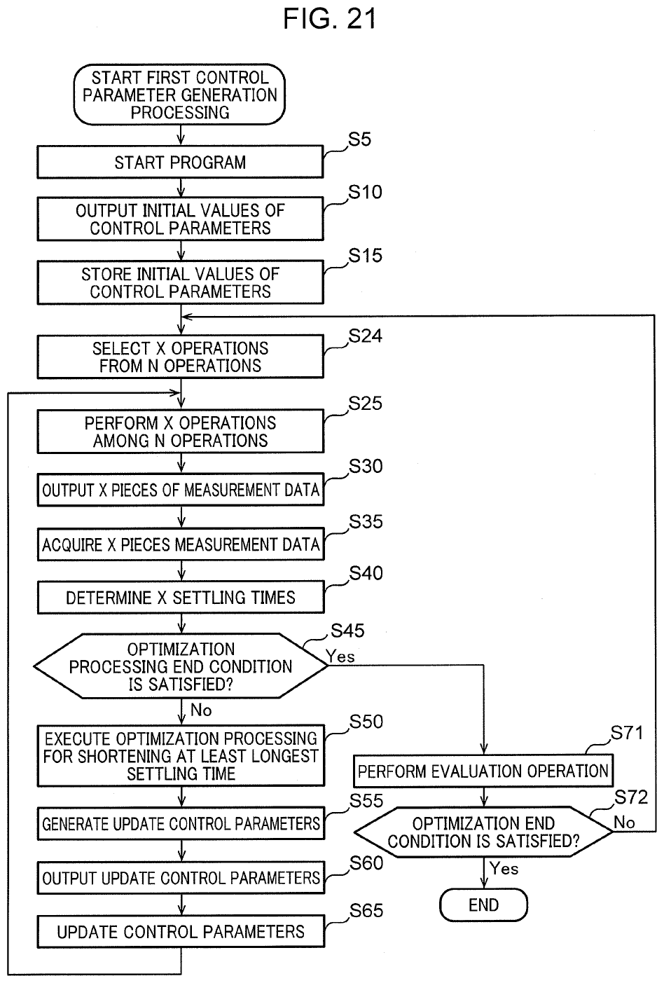

Further, as in the fourth embodiment, at least one evaluation operation may be performed in the middle of the plurality of stages. FIG. 21 is a flowchart of the first control parameter generation processing. As illustrated in FIG. 21, the evaluation operation may be performed after each of the plurality of stages of the control parameter optimization processing (step S71). In a case where the evaluation result satisfies the optimization end condition (step S72: Yes), the optimization processing may end. In a case where the evaluation result does not satisfy the optimization end condition (step S72: No), next X representative operations may be selected (step S24), and the control parameter optimization processing in the next stage may be performed.

### SIXTH EMBODIMENT

In the sixth embodiment, details of the optimization algorithm 140 used by the generation unit 14 will be described. As the optimization algorithm 140, the evolutionary strategy algorithm (CMA-ES) is basically used. Such an algorithm is used for setting a search range of control parameters of update candidates in the next-stage control parameter optimization processing based on a plurality of evaluation values calculated in the current-stage control parameter optimization processing, and further changing an evaluation criterion of the control parameter optimization processing between the current stage and the next-stage. That is, using the optimization algorithm 140, the generation unit 14 executes the first optimization processing on the information (control parameters in this example) using a first evaluation criterion, sets the search range of the information based on the plurality of evaluation values calculated in the first optimization processing, and executes the second optimization processing on the information using a second evaluation criterion different from the first evaluation criterion for the set search range.

Here, changing the evaluation criterion includes changing the representative operation as in the first and fifth embodiments, for example. Changing the representative operation includes, for example, changing the number of operations included in the representative operations in each of the plurality of stages as in the first embodiment. Changing the number of operations includes, for example, increasing the number of operations as the stage proceeds as in the first embodiment. Changing the representative operation includes fixing the number of operations included in the representative operation in each of the plurality of stages as in the fifth embodiment and changing the contents of the operations. Further, changing the contents of the operations includes making the contents of the operations complicated as the stage proceeds as in the fifth embodiment.

In addition, changing the evaluation criterion includes changing an evaluation index in each of the plurality of stages. For example, in a case where the settling time is currently used as the evaluation index, the extent of deviation (an integrated value of a deviation time or a positional deviation amount) is used as the evaluation index in the next stage. Other evaluation indexes different from the settling time and the extent of deviation may be used. Alternatively, the weighted sum of the evaluation indexes of both the settling time and the extent of deviation may be used, and the weight value to be multiplied by each evaluation index may be changed in each of the plurality of stages.

In the information optimization processing, the optimization might proceed faster by using another evaluation index, using a weighted sum of a plurality of evaluation indexes, or using a weighted sum of the evaluation index to be improved and another evaluation index than by using the evaluation index to be finally improved. However, it is not clear which evaluation index is effective to use, or an effective weight value of each evaluation index is unknown. With this method, the generation unit 14 dynamically changes the evaluation index or the weight value to be used so as to be able to cope with a case where the evaluation index or the weight value is unknown. Note that not only the weighted sum but also any evaluation calculation (for example, logarithmic sum) using a plurality of evaluation values of the plurality of evaluation indexes can be used. Further, with this method, the user can select a desired evaluation calculation from a plurality of evaluation calculations stored in advance in the storage unit 42, or the generation unit 14 dynamically changes the evaluation calculation in each stage of the optimization processing.

In addition, the generation unit 14 may repeatedly execute the information optimization processing while stochastically changing the evaluation index or the weight value to be used, and store, in the storage unit 42 or another storage unit, a database in which a correspondence relationship between the used evaluation index or weight value and the final evaluation value of the evaluation index to be improved is accumulated. The progress of the optimization can be promoted by increasing the probability that the evaluation index or the weight value with which the good evaluation value is obtained is easily selected again. Note that the generation unit 14 may change the evaluation index or the weight value to be used at a frequency of each of the plurality of stages of the optimization processing, or at a frequency of once in several stages. Further, the generation unit 14 may randomly change the evaluation index or the weight value to be used in each stage, may use the same evaluation index or weight value in the plurality of consecutive stages, or may use the same evaluation index or weight value in the plurality of non-consecutive stages.

Since the effective setting of the evaluation index or the weight value to be used changes in each of the plurality of stages in the optimization processing, the progress of the optimization can be promoted by dynamically changing the evaluation index or the weight value as described above.

Furthermore, in a case where a plurality of evaluation indexes is desirably improved at the same time, the generation unit 14 may change the plurality of evaluation indexes alternatively or randomly, or the evaluation index or the weight value to be used, in accordance with a predetermined rule. Here, in a case where the plurality of evaluation indexes includes an evaluation index that has not arrives at a target, the generation unit 14 may increase the frequency of using this evaluation index.

Further, the generation unit 14 may change the evaluation index by switching the sensor to be used for measurement of an object to be measured during the execution of the optimization processing. As one example, the generation unit 14 may first perform rough optimization by using a first sensor that has low measurement accuracy but has high noise resistance and measurement can be performed in a short time, and can perform fine optimization by using a second sensor that has high measurement accuracy but has low noise resistance and requires a long time for measurement because multiple measurements are required.

Further, the generation unit 14 may change the evaluation index by switching the contents of pre-processing to be applied during the execution of the optimization processing. For example, the generation unit 14 may switch to use the measurement data in the time domain obtained from a measured waveform and the measurement data obtained by making frequency analysis on the former measurement data to convert it into a frequency area.

The generation unit 14 may change a parameter to be adjusted during the execution of the optimization processing.

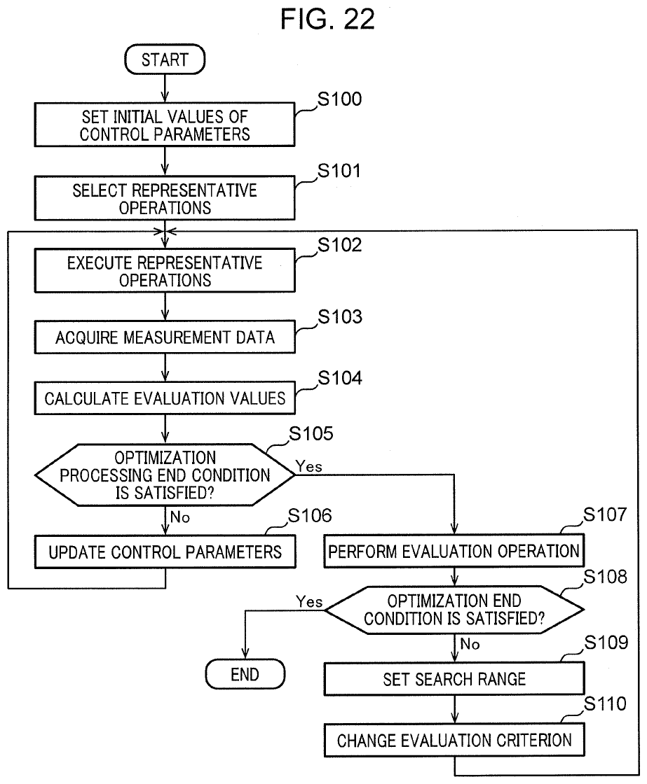

FIG. 22 is a flowchart illustrating a flow of processing executed by the information processing unit 41.

First, in step S100, the generation unit 14 sets initial values of the control parameters as in steps S5 to S20 in FIG. 7.

Next, in step S101, the selection unit 19 selects a representative operation to be executed in the first stage from all the N operations.

In step S102, the control unit 18 causes the production device 20 to operate the representative operation selected by the selection unit 19, as in step S25 of FIG. 7.

In step S103, the acquisition unit 11 acquires measurement data regarding the operations of the production device 20, the measurement data being measured by the sensor 30, in the performing of the representative operations, as in steps S30 to S35 of FIG. 7.

In step S104, the determination unit 13 calculates an evaluation value of the evaluation index based on the measurement data acquired by the acquisition unit 11, as in step S40 of FIG. 7.

Next, in step S105, the generation unit 14 determines whether the optimization processing end condition is satisfied.

In a case where the optimization processing end condition is not satisfied (step S105: No), in step S106 the generation unit 14 updates the control parameters based on the evaluation value calculated by the determination unit 13, as in steps S50 to S65 of FIG. 7, and repeats the processing in step S102 and subsequent steps.

In a case where the optimization processing end condition is satisfied (step S105: Yes), in step S107 the control unit 18 causes the production device 20 to perform the evaluation operation as in step S71 of FIG. 21.

Next, in step S108, the generation unit 14 determines whether the evaluation result satisfies the optimization end condition, as in step S72 of FIG. 21.

In a case where the optimization end condition is satisfied (step S108: Yes), the control parameter optimization processing ends.

In a case where the optimization end condition is not satisfied (step S108: No), in step S109 the generation unit 14 uses the optimization algorithm 140 to set the search range of the control parameters of the update candidates in the control parameter optimization processing in the next stage based on the plurality of evaluation values calculated in the control parameter optimization processing at the current stage.

Next, in step S110, the generation unit 14 changes the evaluation criterion (the number of the representative operation in the example of FIG. 7), for example, as in step S75 of FIG. 7. In the control parameter optimization processing in the next stage, the control parameter optimization processing is executed by using the search range set in step S109 and the evaluation criterion changed in step S110.

Note that, also in the sixth embodiment, the image generation unit 16 may generate an image similar to that in FIG. 9 (that is, an image indicating the status of the optimization processing), and the display unit 17 may display the image as in the first embodiment. In this case, the total number of evaluation criteria to be applied may be displayed instead of the “optimization stages” of the image illustrated in FIG. 9. The contents of the evaluation criterion applied in each stage may be displayed instead of the “number of the representative operation”. Instead of the “maximum optimization time”, the maximum execution time of the optimization processing using the evaluation criterion applied to each stage may be displayed. Instead of the “settling time for terminating the optimization”, the target performance (for example, the target evaluation value) of the optimization processing using the evaluation criterion applied to each stage may be displayed. Further, instead of the “minimum settling time”, the best execution value of the optimization processing using the evaluation criterion applied to each stage may be displayed.

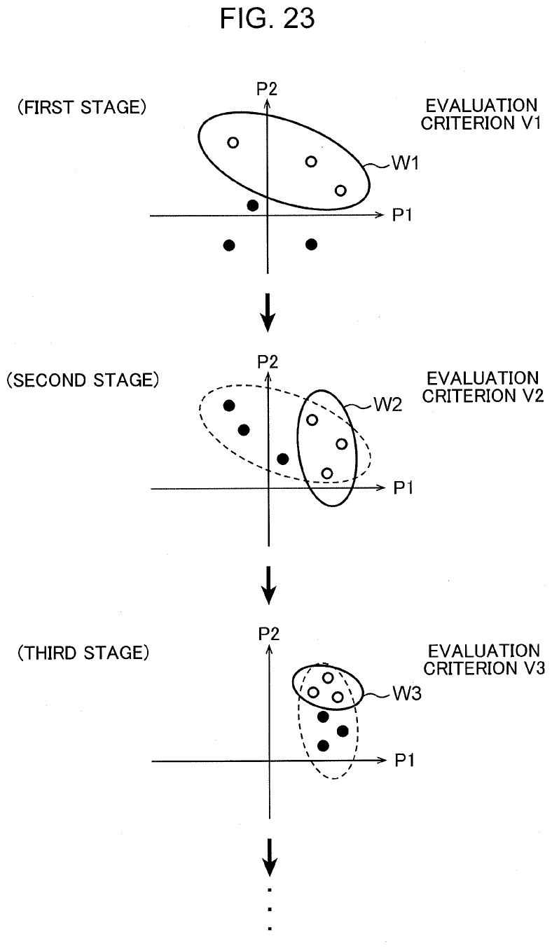

FIG. 23 is a diagram schematically illustrating a method for setting a search range by the generation unit 14. Here, only two control parameters P1 and P2 are focused for simplification. The horizontal axis of coordinates indicates the value of the control parameter P1, and the vertical axis indicates the value of the control parameter P2.

In the first stage, the control parameter optimization processing is executed using an evaluation criterion V1, and a plurality of (six in this example) evaluation values is plotted on the coordinates. Each plotted evaluation value is the worst value among the X evaluation values obtained by the X representative operations. The generation unit 14 designates a plurality of top evaluation values from the plurality of the plotted evaluation values. In FIG. 23, the plurality of top evaluation values are plotted with white circles, and the other evaluation values are plotted with black circles. The generation unit 14 calculates the center coordinates and the covariance matrix of the plurality of top evaluation values using the optimization algorithm 140 of CMA-ES to set a next-stage search range W1. The wide search range W1 is set when the plurality of top evaluation values is dispersed in a wide area, and the narrow search range W1 is set when the plurality of top evaluation values is concentrated in a narrow area.

In the second stage, the control parameter optimization processing is executed for the search range W1 using an evaluation criterion V2 different from the evaluation criterion V1, and a plurality of (six in this example) evaluation values is plotted on the coordinates. As described above, the generation unit 14 designates a plurality of top evaluation values from the plurality of plotted evaluation values, and calculates the center coordinates and the covariance matrix of the plurality of upper evaluation values using the optimization algorithm 140 of CMA-ES to set a next-stage search range W2.

In the third stage, the control parameter optimization processing is executed for the search range W2 using an evaluation criterion V3 different from the evaluation criterion V2, and a plurality of (six in this example) evaluation values is plotted on the coordinates. As described above, the generation unit 14 designates a plurality of top evaluation values from the plurality of plotted evaluation values, and calculates the center coordinates and the covariance matrix of the plurality of top evaluation values using the optimization algorithm 140 of CMA-ES to set a next-stage search range W3. Hereinafter, the same processing as described above is repeatedly executed in the fourth and subsequent stages, and the values of the control parameters P1 and P2 that finally give the best evaluation values are adopted.

According to the sixth embodiment, the control parameter optimization processing is executed a plurality of times while the evaluation criterion of the control parameter optimization processing is being changed. As described above, the appropriate control parameters can be efficiently generated by repeatedly executing the control parameter optimization processing while changing the evaluation criterion.

In addition, by taking over the setting information about the search range W of the control parameters from the current (current-stage) control parameter optimization processing to the next (next-stage) control parameter optimization processing, appropriate control parameters can be efficiently search for in the next control parameter optimization processing.

In the sixth embodiment, the description has been given by using a simple implementation example of the CMA-ES which is one example of the evolution strategy. However, a more complicated implementation or another scheme of the evolution strategy may be used.

### SEVENTH EMBODIMENT

The seventh embodiment will illustrate a method for notifying the user of status information indicating the progress of the control parameter optimization processing and the operation condition. Each operation performed by the production device 20 is an operation performed by the production device 20 to move the object to be driven 24 to a target position.

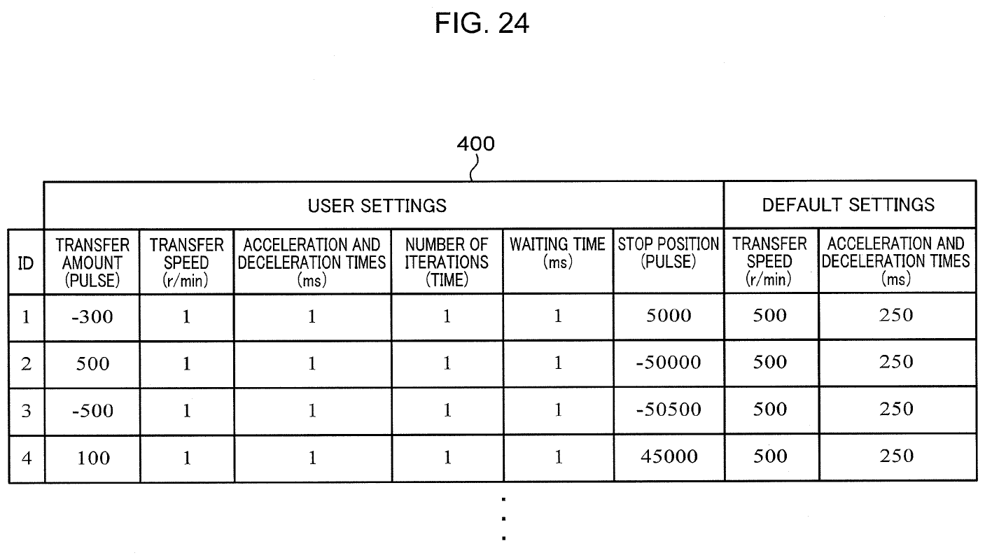

FIG. 24 is a diagram illustrating a part of operation condition information 400 in which an execution condition of each operation performed by the production device 20 is partially simplified and to be described. The operation condition information 400 is stored in the storage unit 42. The operation condition information 400 includes an ID as identification information regarding each operation performed by the production device 20. The operation condition information 400 further includes user setting items regarding a transfer speed, an acceleration and deceleration time (an acceleration time and a deceleration time), the number of iterations, a waiting time, and a stop position associated with each ID. Note that the operation condition is not limited to the example illustrated in FIG. 24 as long as the condition includes at least one item of ID, transfer amount, transfer speed, acceleration time, and deceleration time. Further, the condition may include other items not illustrated in FIG. 24. A user can randomly set the operation condition of each operation by operating the input unit 44 to input the condition setting information. Further, the user can randomly set the maximum time of continuing the control parameter optimization processing and the maximum number of times of updating the control parameters by operating the input unit 44 to input the condition setting information. The operation condition information 400 further includes default setting items related to the transfer speed and the acceleration and deceleration times associated with each ID. When the user does not input the condition setting information through the input unit 44, the respective default setting values are used for the transfer speed and the acceleration and deceleration times. Note that, in a case where different operation conditions are set by default for each device to be adjusted, the user may input device selection information for selecting the device to be adjusted through the input unit 44 so that the default setting value appropriate for the selected device is used.

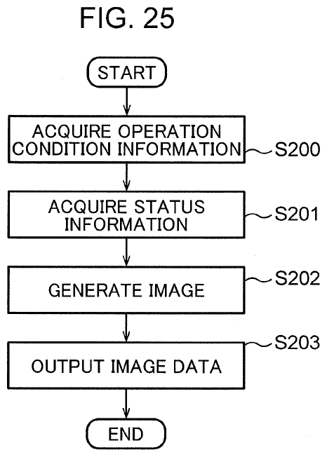

FIG. 25 is a flowchart illustrating a flow of the processing executed by the information processing unit 41 in association with a notification of status information to a user.

First, in step S200, the acquisition unit 11 acquires the operation condition information 400 from the storage unit 42.

Next, in step S201, the image generation unit 16 acquires the status information based on the operation condition information 400 acquired by the acquisition unit 11 and the progress information about the control parameter optimization processing. The image generation unit 16 acquires the progress information from the control unit 18. The control unit 18 creates a database of operation history information including the execution time and the operation condition for each operation performed by the production device 20 in the control parameter optimization processing, and records the database in the storage unit 42. The output unit 12 can display the operation history information read from the storage unit 42 on the display unit 17 or output the operation history information to the outside.

The operation condition information 400 includes information about the maximum time for continuing the control parameter optimization processing set based on the condition setting information and the maximum number of times of updating the control parameters. The progress information includes information indicating a stage currently being executed among the plurality of stages of the control parameter optimization processing, and information indicating an operation currently being adjusted in the plurality of representative operations. Further, the progress information includes information regarding the elapsed time (elapsed time after the start of adjustment) and the number of update times of control parameters (the number of parameter update times) from the start of the first-stage control parameter optimization processing to the present. The image generation unit 16 calculates the remaining time (adjustment remaining time) until the maximum time by subtracting the elapsed time after the start of adjustment until the present from the maximum time, and calculates the remaining number of times (the number of update remaining times) until the maximum number of times by subtracting the number of parameter update times until the present from the maximum number of times.

In step S202, the image generation unit 16 generates a status notification image for notifying the user of the status information.

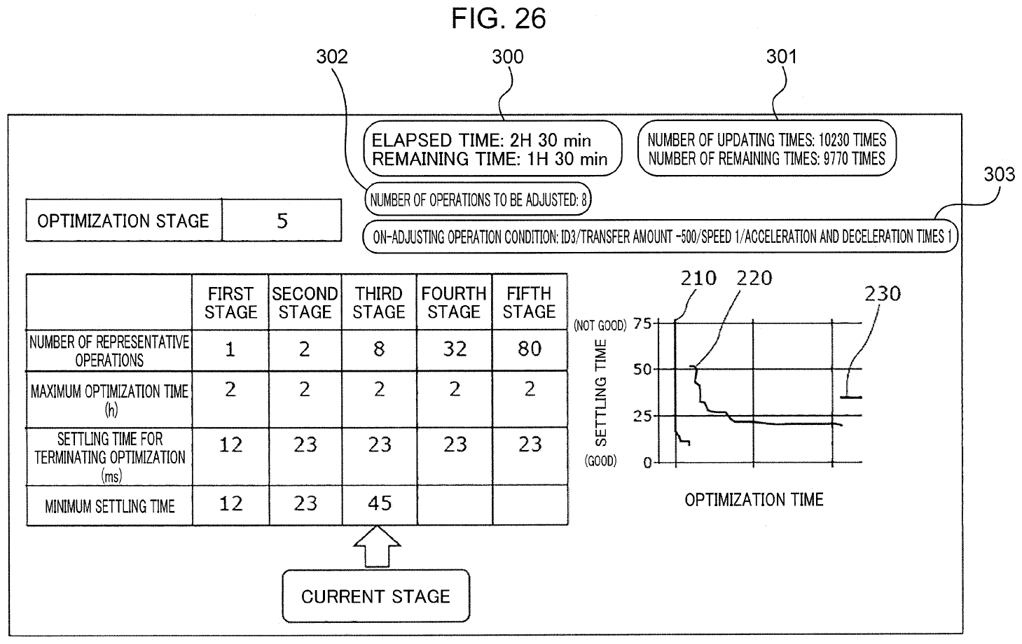

FIG. 26 is a diagram illustrating one example of the status notification image. The status notification image includes items 300 indicating an elapsed time (the elapsed time after the start of adjustment) and a remaining time (the remaining time of adjustment), items 301 indicating the number of update times (the number of parameter update times) and the number of remaining times (the number of update remaining times), an item 302 indicating the current number of operations to be adjusted (that is, the current number of representative operations), and items 303 indicating operation conditions related to an operation currently being adjusted among the representative operations. Note that the status notification image is not limited to the example illustrated in FIG. 26, and the information illustrated in FIG. 26 may be partially omitted, or other information not illustrated in FIG. 26 may be further included. Further, regarding the elapsed time after the start of adjustment, the adjustment remaining time, and regarding the number of parameter update times, and the number of update remaining times, display using a progress bar may be performed so that the user can easily intuitively understand their ratios.

Next, in step S203, the image generation unit 16 inputs image data of the generated status notification image to the display unit 17. The display unit 17 displays the status notification image illustrated in FIG. 26 based on the input image data. Note that a mode of notifying the user of the status information is not limited to image display, and may be voice output or the like from a speaker.

According to the seventh embodiment, by outputting the status information for notification to the user, the user can easily check the progress status, the operation conditions, or the like of the control parameter optimization processing by the notification, and thus, convenience for the user can be improved.

### (Supplementary Information)

The technology disclosed in the present application has been described above based on the first to seventh embodiments. However, the present disclosure is not limited to the first to seventh embodiments. The scope of one or more aspects of the present disclosure may include aspects in which various modifications conceivable by those skilled in the art are applied to the present embodiments or modifications, or aspects formed by combining components in different embodiments or modifications without departing from the gist of the present disclosure.

(1) The first to seventh embodiments has illustrated, as one example, that the control parameter generation devices 10 and 10A are implemented by one computer device. However, the control parameter generation devices 10 and 10A are not necessarily limited to the example achieved by one computer device as long as the same functions can be achieved. The control parameter generation devices 10 and 10A may be achieved by, for example, a plurality of computer devices capable of communicating with each other.

(2) The comprehensive or specific aspects of the present disclosure may be implemented by a system, a device, a method, an integrated circuit, a computer program, or a computer-readable non-transitory recording medium such as a compact disc read only memory (CD-ROM). Further, the aspects may be implemented by a random combination of a system, a device, a method, an integrated circuit, a program, and a non-transitory recording medium. For example, the present disclosure may be implemented as a program for causing a computer device to execute processing executed by a control parameter generation device.

### INDUSTRIAL APPLICABILITY

The present disclosure is widely applicable to a system or the like that generates control parameters.

1. An information processing method for optimizing a plurality of control parameters in a device that performs a plurality of operations based on the plurality of control parameters, the method comprising:
by an information processing device,
in control parameter optimization processing, selecting a representative operation including at least one operation among all of the plurality of operations capable of being performed by the device, causing the device to perform the selected representative operation, acquiring measurement data regarding an operation of the device, the measurement data being measured by performing the representative operation, calculating an evaluation value of a predetermined evaluation index based on the acquired measurement data, and updating the plurality of control parameters based on the calculated evaluation value; and
executing the control parameter optimization processing a plurality of times while changing an evaluation criterion of the control parameter optimization processing.

2. The information processing method according to claim 1, wherein the changing the evaluation criterion includes changing the representative operation.

3. The information processing method according to claim 2, wherein the changing the representative operation includes changing a number of operations in the representative operation.

4. The information processing method according to claim 3, wherein the changing the number of operations includes increasing the number of operations.

5. The information processing method according to claim 2, wherein the changing the representative operation includes changing contents of an operation included in the representative operation.

6. The information processing method according to claim 5, wherein the changing the contents of the operation includes making the contents of the operation complicated.

7. The information processing method according to claim 2, wherein in the changing the representative operation, all of the plurality of operations are classified into a plurality of groups based on similarity, an operation to be improved is designated among the plurality of operations included in each of the plurality of groups based on the evaluation value or a past average value of the evaluation value, and a plurality of the operations to be improved designated for the plurality of groups is selected as the representative operation in the control parameter optimization processing at a next time.

8. The information processing method according to claim 1, wherein the changing the evaluation criterion includes changing the evaluation index.

9. The information processing method according to claim 8, wherein
each of the plurality of operations is an operation for causing the device to transfer an object to a target position, and
the evaluation index includes a settling time until a positional deviation between a position of the object and the target position converges within an allowable range.

10. The information processing method according to claim 8, wherein
each of the plurality of operations is an operation for causing the device to transfer an object to a target position, and
the evaluation index includes an integrated value of a deviation time at which a positional deviation between a position of the object and the target position deviates from an allowable range or of a positional deviation amount.

11. The information processing method according to claim 1, further comprising setting a search range of the control parameters that are update candidates in the control parameter optimization processing at a next time, based on a plurality of the evaluation values calculated in the control parameter optimization processing at a current time.

12. The information processing method according to claim 1, further comprising:
causing the device to perform a predetermined evaluation operation for comprehensively evaluating an operation of the device in comprehensive evaluation processing; acquiring measurement data regarding the operation of the device measured in the performing of the evaluation operation;
calculating an evaluation value of the evaluation index based on the acquired measurement data;
and making the comprehensive evaluation based on the calculated evaluation value.

13. The information processing method according to claim 12, wherein the evaluation operation is all the operations.

14. The information processing method according to claim 12, wherein the evaluation operation is a differential operation between all the operations and a most recent representative operation with respect to the evaluation operation.

15. The information processing method according to claim 12, wherein the evaluation operation is a prescribed operation defined in advance from all the operations.

16. The information processing method according to claim 12, further comprising:
determining whether the evaluation result of the comprehensive evaluation satisfies a predetermined end condition; and ending the control parameter optimization processing in a case where the evaluation result satisfies the end condition.

17. The information processing method according to claim 1, wherein each of the plurality of operations is an operation for causing the device to transfer an object to a target position,
the method further comprising outputting, to a user for a notification, status information regarding at least one of:
an elapsed time from start of the control parameter optimization processing;
a remaining time until a maximum time for continuing the control parameter optimization processing;
an operation condition including at least one of identification information, a transfer amount, a transfer speed, an acceleration time, and a deceleration time regarding an operation being currently performed among the at least one operation included in the representative operation;
a number of operations included in the representative operation;
a number of update times of the control parameters; and
a remaining number of times up to a maximum number of times of updating the control parameters.

18. The information processing method according to claim 17, further comprising updating the status information every time the evaluation criterion is changed.

19. The information processing method according to claim 17, further comprising setting the maximum time, the operation condition, and the maximum number of times based on condition setting information input by a user.

20. The information processing method according to claim 17, wherein
the operation condition is preset for each device,
the method further including setting the operation condition in accordance with the selected device based on device selection information input by a user.

21. The information processing method according to claim 1, further comprising recording operation history information including a performing time and an operation condition for each operation performed by the device in the control parameter optimization processing.

22. An information optimization method comprising:
by an information processing device,
executing first optimization processing on information using a first evaluation criterion;
setting a search range of the information based on a plurality of evaluation values calculated in the first optimization processing; and
executing second optimization processing on the information regarding the set search range using a second evaluation criterion.

23. An information processing device that optimizes a plurality of control parameters in a device that performs a plurality of operations based on the plurality of control parameters, comprising a processor,
wherein the processor in control parameter optimization processing,
selects a representative operation including at least one operation among all of the plurality of operations capable of being performed by the device,
causes the device to perform the representative operation,
acquires measurement data regarding an operation of the device measured in performing the representative operation,
calculates an evaluation value of a predetermined evaluation index based on the measurement data,
updates the plurality of control parameters based on the evaluation value, and
the control parameter optimization processing is executed a plurality of times while an evaluation criterion of the control parameter optimization processing is being changed.

24. A computer-readable non-transitory recording medium recording a program for causing an information processing device to perform a process, the information processing device optimizing a plurality of control parameters in a device that performs a plurality of operations based on the plurality of control parameters,
wherein the information processing device, by executing the program, in the control parameter optimization processing,
selects a representative operation including at least one operation among all of the plurality of operations capable of being performed by the device,
causes the device to perform the representative operation,
acquires measurement data regarding an operation of the device measured in performing the representative operation,
calculates an evaluation value of a predetermined evaluation index based on the measurement data,
updates the plurality of control parameters based on the evaluation value, and
the control parameter optimization processing is executed a plurality of times while an evaluation criterion of the control parameter optimization processing is being changed.
